(19) United States
(12) Patent Application Publication
(10) Pub. No.: US 2017/0349487 A1
(43) Pub. Date: Dec. 7, 2017

(54) Fibers for Reinforcing Concrete

(71) Applicant: ABC POLYMER INDUSTRIES, LLC, Helena, AL (US)

(72) Inventors: Bobby Zellers, Helena, AL (US); Dean Leader, Helena, AL (US)

(21) Appl. No.: 15/684,541

(22) Filed: Aug. 23, 2017

Related U.S. Application Data
(63) Continuation of application No. PCT/US17/18968, filed on Feb. 22, 2017.
(60) Provisional application No. 62/298,287, filed on Feb. 22, 2016.

(51) Int. Cl. C04B 16/06; D01F 6/46

(52) U.S. Cl. CPC C04B 16/0633; D01F 6/46; C04B 16/0625; D10B 2321/021; D10B 2401/00; D10B 2505/02; D10B 2321/022

(57) ABSTRACT

The invention is an improved macrosynthetic fiber for concrete reinforcement.

This application is a continuation of International patent application number PCT/US2017/018968, filed Feb. 23, 2017 (pending). International patent application PCT/US2017/018968 claims priority to and the benefit of, U.S. provisional application No. 62/298,287 filed on Feb. 22, 2016 (expired). The foregoing applications are incorporated by reference in their entireties.

The field of the invention is discrete macrosynthetic fibers for use in reinforcing concrete.

The macrosynthetic fiber, the invention disclosed herein, comprises a blend of polypropylene and polyethylene resins, or can comprise one or the other of these materials. As used herein, “macrosynthetic fiber” is a fiber having a linear density equal to or greater than 580 deniers and a diameter equal to or greater than three millimeters (3 mm). In a preferred embodiment of the fiber, it is 1800 deniers with an approximate range of +/−30%. ASTM standard D7508 is hereby incorporated by reference. The fiber is flexible compared to other fibers, as can be demonstrated in testing of the individual fiber's modulus of elasticity. The flexibility of the fiber, along with its other properties and configuration, aid in the workability of the fiber into the concrete in a uniform manner, adding to the strength of the hardened concrete.

### BRIEF DESCRIPTION OF THE FIGURES

FIGS. 1A-1C are cross-sections of some examples of fibers comprising a U-shape embodiment, and FIG. 1D is a schematic of the axes of the U-shape embodiments.

FIGS. 2A-2B are cross-sections of some examples of fibers comprising an H-shape embodiment, and FIG. 2C is a schematic of the axes of the H-shape embodiment.

FIG. 3 is a cross section of the fiber embodiment of FIG. 1B, showing additional detail.

FIG. 4 is a cross-section of the fiber embodiment of FIG. 2B, showing additional detail.

FIG. 5 is a perspective view of a shortened section of the fiber in an additional U-shape embodiment.

FIG. 6 is the same as FIG. 5, with the areas of joinder shaded.

FIG. 7 is a perspective view of a short section of a U-shape embodiment with indentations from scoring.

FIG. 7A is a perspective view of a U-shape embodiment of an entire fiber as shown in cross-section in FIG. 1B. Here, no indentations are depicted as depicted in FIG. 7.

FIG. 8 is s side view of the scoring tool and a fiber (before cutting) in the process of being scored with indentations.

FIG. 9 shows test results of the present invention fiber at a dose of 3.0 pounds per cubic yard of concrete, as further described in Table 3.

FIG. 100 shows test results of the present invention fiber at a dose of 5.0 pounds per cubic yard of concrete, as further described in Table 4.

FIG. 11 shows test results of the present invention fiber at a dose of 7.0 pounds per cubic yard of concrete, as further described in Table 5.

FIG. 12 shows test results of the present invention fiber at a dose of 10.0 pounds per cubic yard of concrete, as further described in Table 6.

FIG. 13 shows comparative test results of the present invention and prior art fibers A-I with loading values at L/600 and L/150 at a dose of 5.0 pcy, with data from Table 8.

FIG. 14 shows test results of prior art fiber A at a dose of 5.0 pounds per cubic yard of concrete, as further described in Table 9.

FIG. 15 shows test results of prior art fiber B at a dose of 5.0 pounds per cubic yard of concrete, as further described in Table to.

FIG. 16 shows test results of prior art fiber C at a dose of 5.0 pounds per cubic yard of concrete, as further described in Table 11.

FIG. 17 shows test results of prior art fiber D at a dose of 5.0 pounds per cubic yard of concrete, as further described in Table 12.

FIG. 18 shows test results of prior art fiber E at a dose of 5.0 pounds per cubic yard of concrete, as further described in Table 13.

FIG. 19 shows test results of prior art fiber F at a dose of 5.0 pounds per cubic yard of concrete, as further described in Table 14.

FIG. 20 shows test results of prior art fiber G at a dose of 5.0 pounds per cubic yard of concrete, as further described in Table 15.

FIG. 21 shows test results of prior art fiber H at a dose of 5.0 pounds per cubic yard of concrete, as further described in Table 16.

FIG. 22 shows test results of prior art fiber I at a dose of 5.0 pounds per cubic yard of concrete, as further described in Table 17.

FIG. 23 is a depiction of summary test results on the present invention fibers at doses of fiber at 3.0, 5.0, 7.0 and 10.0 pounds per cubic yard of concrete with data taken from Table 2.

FIG. 24 depicts an embodiment of the present invention without areas of joinder.

FIG. 25 is a photograph of individual fibers of the present invention, as well as in pucks, or packages, for mixing in concrete.

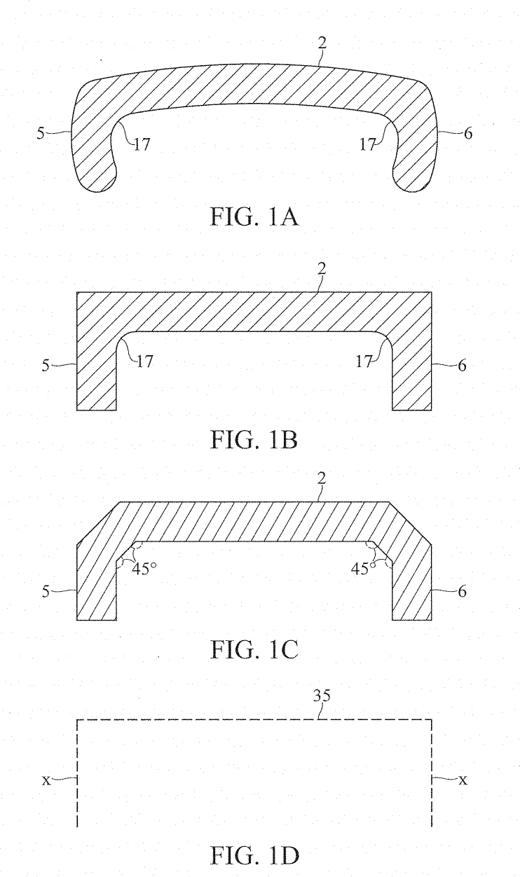

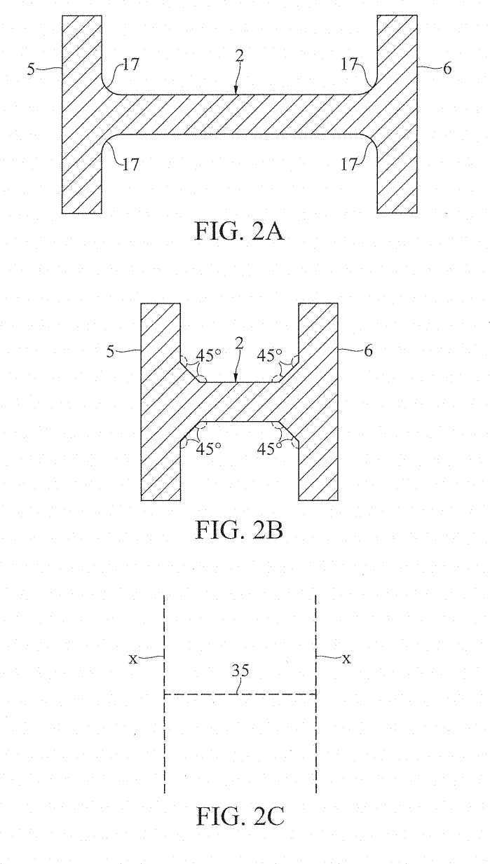

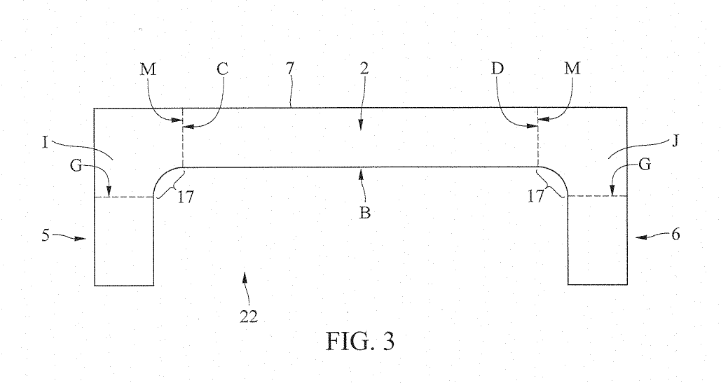

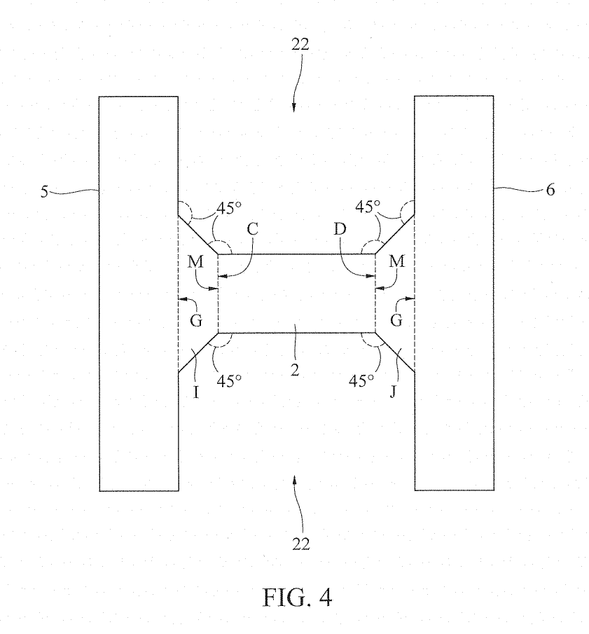

The present invention embodies a number of unique configurations to maximize surface area to enhance mechanical bonding of the fiber to hardened concrete. The cross-section of one embodiment of the invention comprises a “U-shape” as shown, for example, in FIGS. 1A-1C to allow the un-hardened concrete mix to enter a single valley 22 (i.e., open space) defined by the walls 5, 6 and the central panel 2 of the fiber embodiment. The cross-section of another embodiment comprises an “H-shape” as shown, for example, in FIGS. 2A-B which also allows the un-hardened concrete mix to enter the two valleys 22 of this embodiment of the fiber and bond to the walls 5, 6, central panel 2 and the area of joinder I, J, particularly the radius 17 or two or more angles. These embodiments provide extra surface area for bonding and also allow the concrete hardened inside the valley(s) 22 and exterior to the valley(s) to provide pressure to the walls 5, 6 of the fiber to reduce the effect of Poisson's Ratio. Poisson's Ratio is the ratio of the transverse contraction strain to the longitudinal extension strain in the direction of stretching force, i.e., the fiber becomes thinner as it is elongated. For example, gripping a rubber band between the thumb and forefinger of both hands and stretching is a simple demonstration of Poisson's Ratio. With the present invention fibers, hardened concrete which is bonded to both sides of the walls 5, 6 in the U-shape embodiment or the H-shape embodiment resists the elongation of the fiber and thus adds to the strength of the reinforced concrete. The hardened concrete bonded in the valley(s) 22 of the U-shape or of the H-shape coupled with the hardened concrete bonded to the exterior to the walls (including upper and lower) forms a vise grip on the walls. In most cases with a prior art fiber (either flat or round) a slip plane develops at the surface of the fiber, if there is no deformation to create a mechanical bond. The surface area and any surface deformations will affect the amount of friction forces. The present invention does employ surface friction but also employs mechanical bonding.

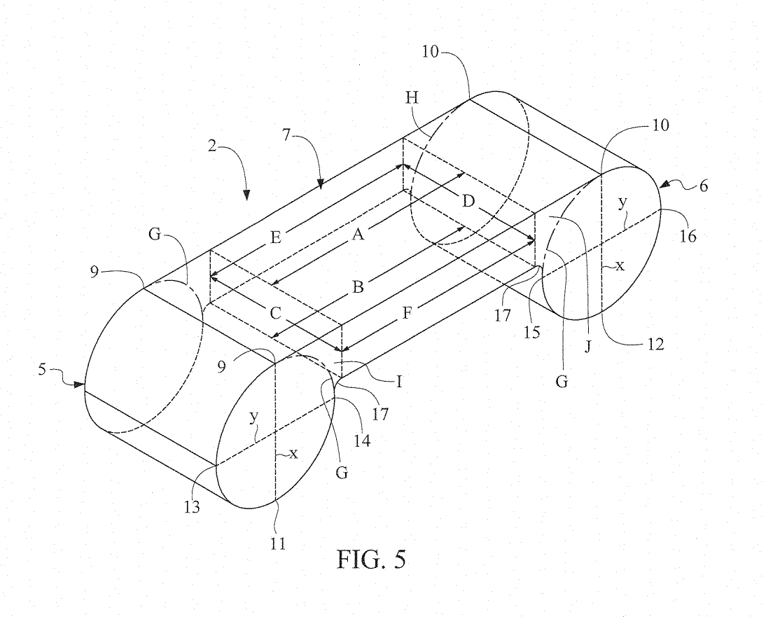

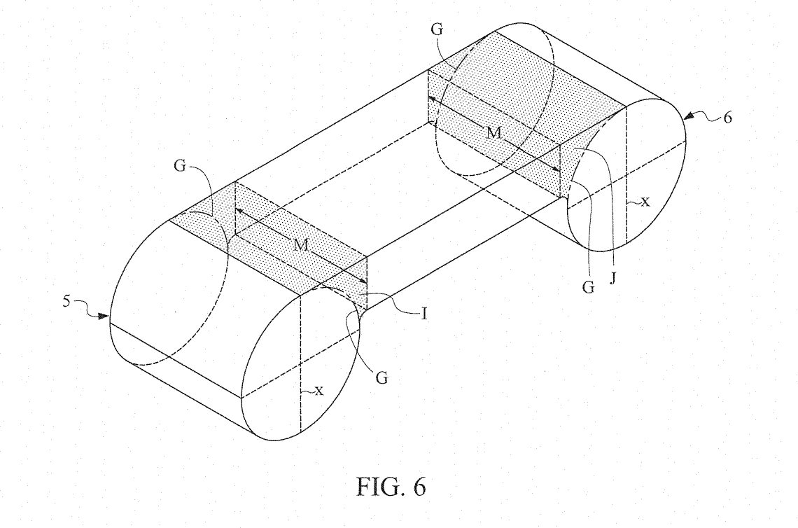

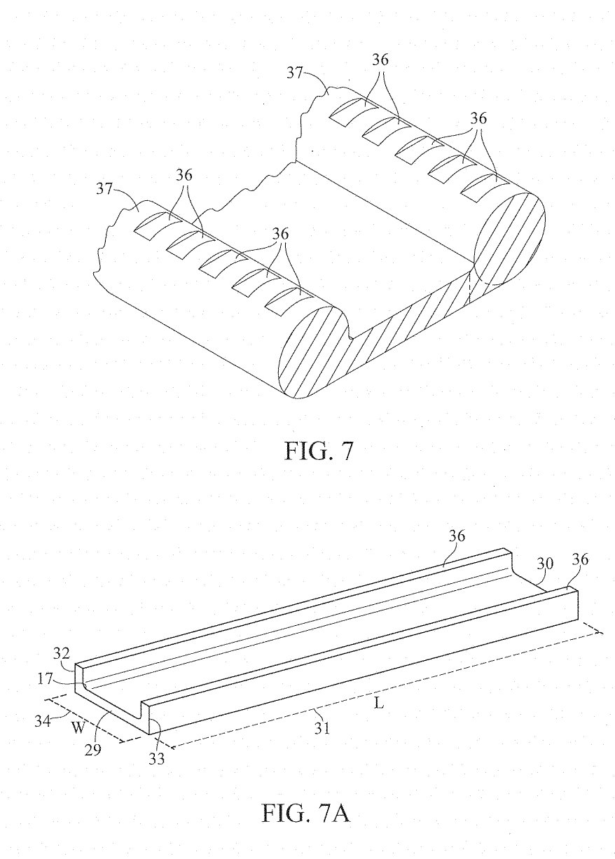

An embodiment of the invention as shown in FIG. 7A is an entire macrosynthetic fiber for reinforcing concrete comprising two ends 29, 30 defining a length 31 and two sides 32, 33 defining a width 34, a central panel 2 spanning the length 31 of the fiber and comprising a central panel axis 35 (FIG. 1A) and two borders C, D, two areas of joinder I, J spanning the length 31 of each fiber and each said area of joinder I, J comprising two faces G, M and two walls 5, 6 spanning the length of the fiber and each said wall 5, 6 comprising a wall axis X substantially parallel to the other wall axis X, each border C, D of said central panel 2 being integral to one of said areas of joinder I, J at one of said faces M, and the other face G of each said area of joinder I, J being integral to one of the walls 5, 6. In FIGS. 5 and 6, face G is denoted with dot/dash lines instead of dash lines which illustrate unseen structures and, in these two figures, face G is approximately one quarter of the circumferential area of the cylinder. The walls 5, 6 may extend only to one side of the central panel 2 (as in FIGS. A-1C, 3, 5, 6, 7, 7A) having a U-shape cross-section or to both sides of the central panel 2 (as in FIGS. 2A-2C and 4) having an H-shape cross-section along the width. In one embodiment each of the wall axes X is positioned in relation to the central panel axis 35 at an angle of approximately 90 degrees, although the walls and the central panel need not actually intersect where the axes would intersect. The fiber further comprises indentations 36 along the length of the fiber on the ends 37 of the walls or on the central panel, and the indentations provide additional mechanical bonding. The walls may comprise an object selected from the group consisting of a cylinder, a rectangular prism, and an elliptical prism. At least one of said areas of joinder I, J may comprise a radius 17 of approximately 0.0040 inches and at least one of said areas of joinder may comprise two or more angles having a sum totaling 90 degrees, as shown for example in FIG. 1C. As a result of the above configuration and properties, when the fiber is mixed at a dose exceeding three pounds per cubic yard of concrete, the concrete when hardened has a greater load value in a net deflection of L/150 than in a net deflection of L/600. Moreover, the difference in the load value in the net deflection of L/150 over the net deflection of L/600 increases as the dose of the fiber increases. As to overall dimensions, the fiber length 31 is preferably within a range of approximately 1.0-3.0 inches (25 mm-75 mm) the fiber width 34 is preferably within a range of approximately 0.020-0.060 inches (0.5 mm-1.5 mm).

The invention shown, for example, in embodiments 1A-1C, 3, 5, 6, 7, 7A is a macrosynthetic fiber comprising a cross-section comprising a U-shape, wherein the walls 5, 6 extend only to one side of the central panel 2, said cross-section comprising a central panel 2 comprising two borders C, D (depicted in FIG. 5) and a central panel axis 35, two walls 5, 6 each comprising a wall axis X, and two areas of joinder I, J comprising two faces G, M (as depicted in FIG. 6), each border C,D being integral to one of the areas of joinder at one of the faces M and the other face G being integral to one of the walls, one of said wall axes X being substantially parallel to the other wall axis X. The central panel and said walls define a valley 22, i.e., a space between said central panel and said walls. At least one of the areas of joinder I, J comprises a radius 17 in a range of 0.0020-0.0060 inches (0.5 mm-1.5 mm), or at least one of the areas of joinder comprises two or more angles having a sum totaling 90 degrees, as shown in FIG. 1C. The fiber walls 5, 6 further appear in cross-section to comprise an object selected from the group consisting of a circle, a rectangle and an ellipse. The fiber in cross-section comprises a width within a range of 0.020 to 0.060 inches (0.5 mm-1.5 mm).

The invention in another embodiment is a macrosynthetic fiber in cross-section comprising an H-shape as in FIGS. 2A, 2B and 4, said cross-section comprising a central panel 2, two borders (depicted as C, D in FIG. 5) and a central panel axis 35, two walls 5, 6 and each of said walls extending to opposite sides of the central panel axis 35 and comprising a wall axis X, and two areas of joinder I, J each comprising two faces G, M, each border C, D being integral to one of the areas of joinder at one of the faces and the other face of each area of joinder being integral to one of the walls, each said wall axis being substantially parallel to the other wall axis. The central panel and said walls 5, 6 define a two valleys 22. At least one of the areas of joinder comprises a radius in a range of 0.020 to 0.060 inches (0.5 mm-1.5 mm), and at least one of the areas of joinder comprises two or more angles having a sum totaling 90 degrees (as in FIGS. 1C, 2B and 4). In cross-section, the walls appear to comprise an object selected from the group consisting of a circle, a rectangle and an ellipse. In another embodiment, in cross-section the walls may appear to be an amorphous object. As to overall dimension, the cross-section comprises a width within a range of 0.020 to 0.060 inches 0.020 to 0.060 inches (0.5 mm-1.5 mm).

In Fiber Reinforced Concrete the present invention fills a void created by itself in the properly consolidated fresh/plastic concrete. When the concrete hardens, there is a mechanical bond created between the hardened concrete and the invention. If a fiber intercepts a crack, there is a stress applied to the fiber, and the fiber then can break or it can de-bond thereby losing its bond to the concrete. If de-bonding occurs, the fiber will stretch/decrease in cross-section and vacate the volume it occupies in the hardened concrete. The fiber pulls out of the concrete on one side of the crack while remaining anchored to some degree on the other side of the crack. Since there is typically an uneven length of the fiber on either side of the crack, the side with the longest “bond length” will control. Bond length is a percentage of the overall length of the fiber that occupies one side of the crack or the other. Thus, by way of example only, if there is a 1″ long fiber and ¾″ is on one side of the crack and ¼″ o the other, then the ¾″ long fiber with a bond length of ⅝″ would control.

The embodiment of the present invention fiber for which data is presented herein comprises a blend of polyethylene and polypropylene extruded in a single from a die opening. In the “U” shaped embodiment of the present invention comprising walls comprising cylinders, the overall width of the die opening from one side to another is approximately 0.200 inches (5.0 mm). In the die opening in one embodiment, the thickness of the die opening at the central panel (between planes B and E) is approximately 0.0200 inches (0.50 mm), the diameter of the die opening for the circles is approximately 0.0530 inches (1.235 mm), the radius of the die at the intersection of the central panel and the bottom plane of the central panel are approximately 0.0040 inches (0.1 mm). The distance between the centers of the circles in the die opening is 0.1470 (3.675 mm) in one embodiment. From the die opening with the dimensions listed above, after being drawn in a water bath and stretched in an oven, final dimensions for one embodiment of the fiber cross-section is approximately 0.040 inch (1.0 mm) wide from the farthest extending points on each circle and approximately 0.013 inches (0.325 mm) thick at the central panel. All of these values are exemplary and may be varied from embodiment to embodiment.

After extrusion from a die, the fiber cross-section dimensions are reduced from the dimensions of the die opening as the polymer is drawn into a water bath and also when it is stretched in an oven. After extrusion, the extruded fiber is cut into discrete fibers 1 whose preferred length in one embodiment is within a range of approximately 1.0-3.0 inches (25 mm-75 mm), and in one embodiment, approximately 1.5 inches (38 mm). A portion of a single fiber is depicted in FIG. 7 showing scoring in one embodiment on the ends 37 of walls 5, 6 (in one embodiment centered at points 11, 12 on FIG. 5) and, in another embodiment, the scoring can be on the opposite side (along top plane 7, or centered on points 9 or 10 on FIG. 5). In the embodiment in FIGS. 5, 6, 7, 7A, the width of a single fiber is from element 13 to element 16 in FIG. 5. A single fiber, after it has been extruded and later cut, has a preferred length within a range of approximately 1.0-3.0 inches and an overall width of 0.040, within a range of 0.020-0.060 inches. The diameter of the walls is approximately 0.013 inches. The thickness of the central panel from the top plane A to the bottom plane B, in one embodiment, is about 0.007 inch, within a range of about 20% +/−. All of these values are exemplary and may be varied.

The fiber 1 in one embodiment shown in FIG. 5 comprises a central panel 2, two areas of joinder I, J and two walls 5, 6. In this embodiment the central panel is bounded and defined by planes A, B, C, D, E and F and each end C, D of the central panel is integral to one face M of one of the areas of joinder I, J, and the other face G of each of the areas of joinder I, J is integral to one of the walls 5, 6. Planes E and F are the two ends of a fiber as shown in truncated form in FIGS. 5 and 6, or are the planes at the end of the normal fiber length, approximately 1.5-2.0 inches (38 mm-50 mm) in one embodiment, as shown in FIG. 7A.

FIGS. 5 and 6 depict a small section of a single fiber comprising a U-shape. Although none of the figures herein is to scale, the length of the entire fiber (FIG. 7A) appears much greater than it does in FIGS. 5 and 6. That is, the lines at element 9 and element 100 would be much longer in relation to the width of the fiber 34 (also portrayed as the distance from element 13 to element 16 in FIG. 5) for an entire fiber than these lines are in FIG. 2. The central panel 2, in the embodiment as in FIGS. 5, 6, may comprise a rectangle, as shown by planes A-F. In this embodiment, the top-most plane 7 comprises plane A of the central panel 2 but also comprises a surface of the areas of joinder I, J beyond both ends of side A and extending to the topmost point 9, 10 of each cylinder 11, 12. FIGS. 5, 6 show an embodiment with walls 5, 6 comprising a cylinder 11, 12 integral to one area of joinder I, J at one face G and the other face of the area of joinder M is adjacent to a border C,D of the central panel. The cylinders have a top-most point 9, 10 opposite a bottom-most point 11, 12, said topmost and bottom-most points being on opposite ends of the wall axis X which is a diameter bisecting the cylinder. In this embodiment and the H-shape embodiment, but not in all embodiments, the two wall axes X are substantially embodiment. That is, the angles between the central panel axes and the wall axes may exceed 90 degrees. In FIGS. 5 and 6, these top-most 9, 10 and bottom-most 11, 12 points are also described as ends 37 of walls. There are also two points 13-14, 15-16 on opposite ends of line Y (also a diameter) which bisects wall axis X, line Y comprising points 14 and 15 toward the central panel. The bottom-most plane B also extends to the wall in the approximate area of the side point. When the wall is in the embodiment of a cylinder, each end of the bottom plane B extends to near one of the two side points 14, 15. As shown in FIGS. 5 and 6, approximately one quarter of each cylinder is integral to face G of the area of joinder integral to the end of the central panel, from point 9 to point 14, and from point 10 to point 15. In FIG. 5, said top plane A and bottom plane B are, in one embodiment, substantially parallel to one another, but they need not be substantially parallel in all embodiments. In other embodiments, the exterior surfaces of the central panel connecting the areas of joinder need not be planar, but may be irregular in shape. In the embodiment depicted in FIG. 5, at the area of joinder, there is a radius 17 which, in one embodiment is preferably 0.0040 inch, or within a range of 0.002 to 0.008 inch. The radius must be large enough to allow the components of the concrete to substantially fill the radius. The sieve for a sand typical of concrete has its smallest holes with an opening of 0.0029 inches so the sand grains do not exceed that dimension. A radius where the area of joinder is exposed to the valley 22 increases the ability of the concrete components to fill the joint between the central panel and the wall, but an angle of at least 90 degrees is also acceptable in some embodiments. The areas of joinder I, J may comprise a radius 17 or at least two angles whose sum totals 90 degrees.

In FIG. 5, the distance of wall axes X and lines Y, in one embodiment, is approximately 0.013 inches. The depth of the indentations is affected by the gap setting on the texturizer 23 and a fiber's tendency to return to its original dimension. In one embodiment the present invention fibers are 0.013 inches thick and are processed with a gap of 0.006 to 0.007 inches, and the thickness at the impression measures 0.0095 inches.

FIG. 6 depicts the same embodiment as in FIG. 5, but two areas of joinder I, J are represented as shaded areas in FIG. 6 for better viewing. In this embodiment where the walls 5, 6 project only to one side of the profile (i.e., bottom plane B) of the central panel 2, and the walls and central panel define a U-shaped valley 22, as shown in the embodiments depicted in Figures A-1C, 3 and 5, 6, 7, 7A. The cross-section of the central panel 2 may comprise any shape selected from the group consisting rectangle, ellipse, oval and squoval. In another embodiment, in cross-section the walls may appear to be an amorphous object.

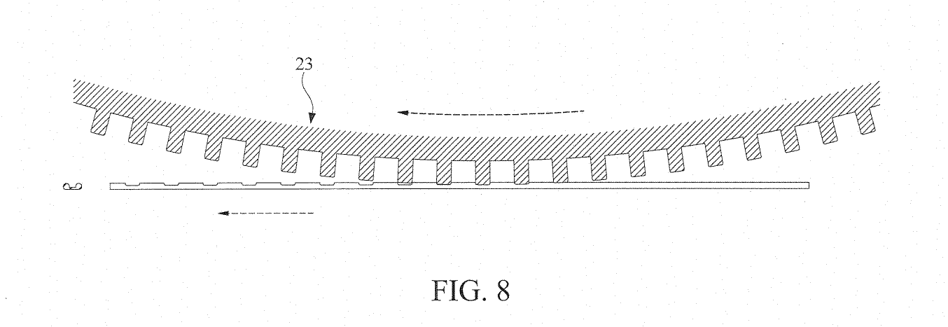

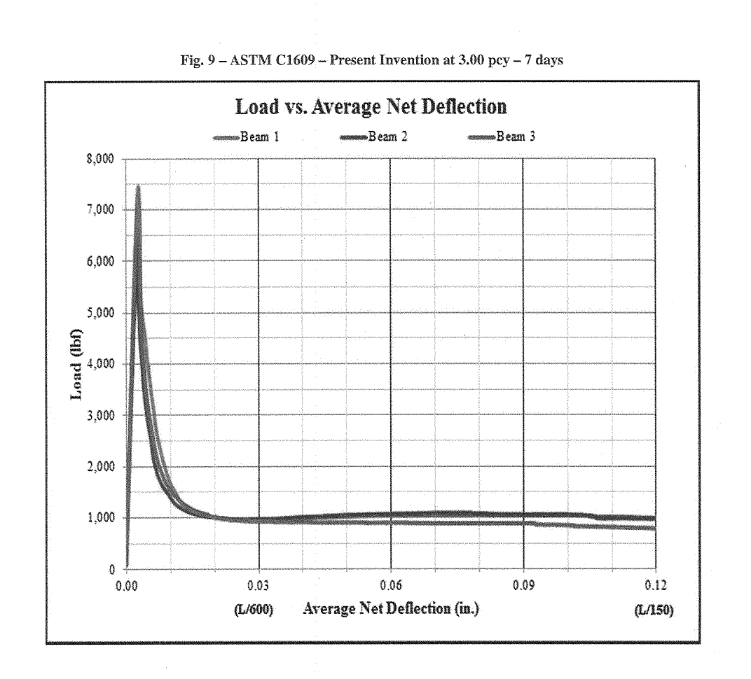

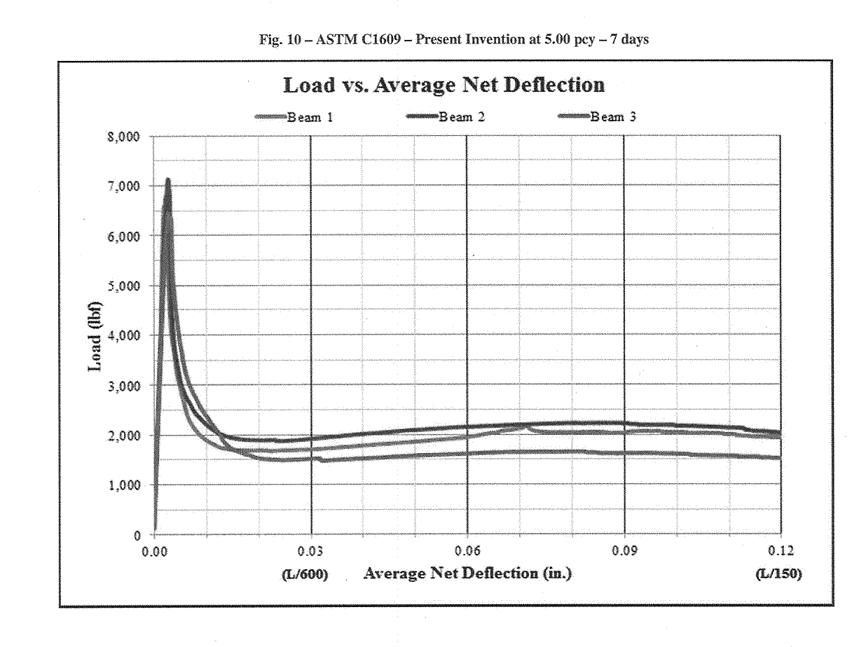

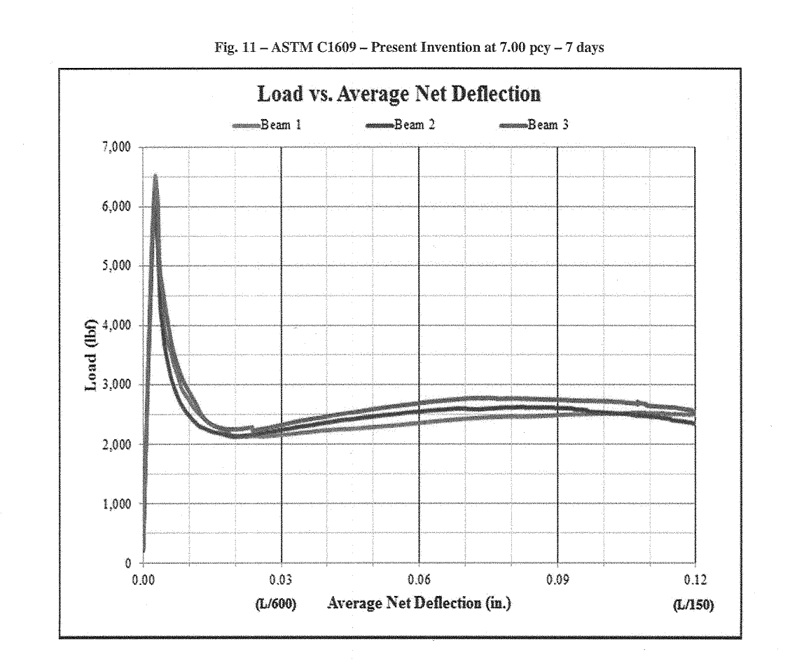

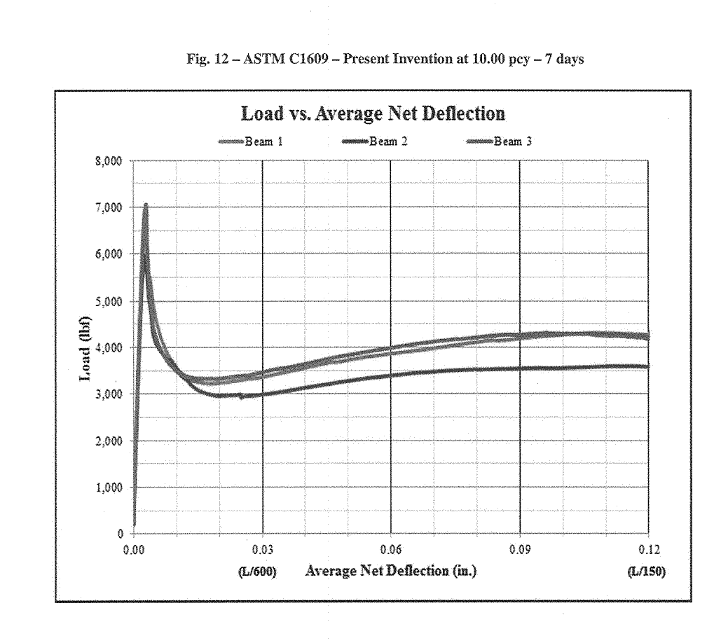

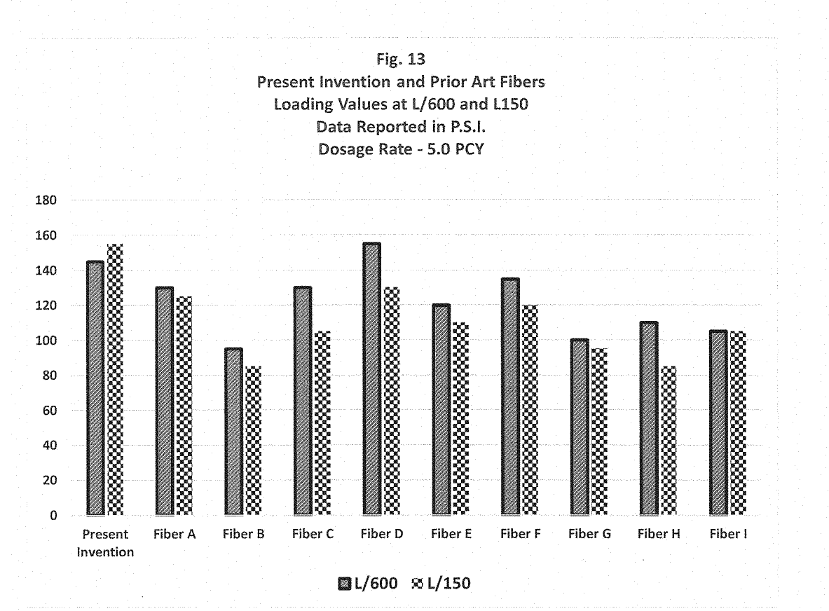

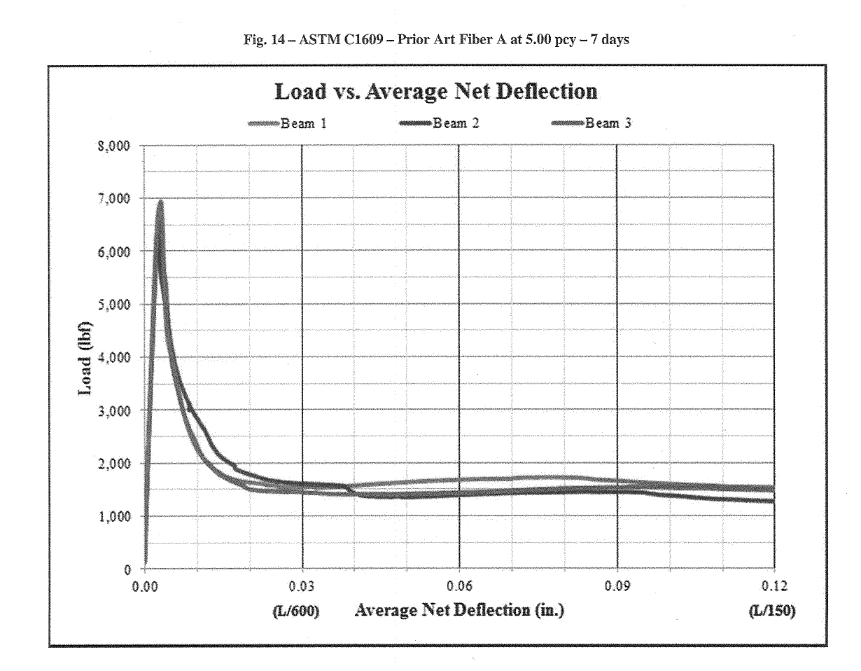

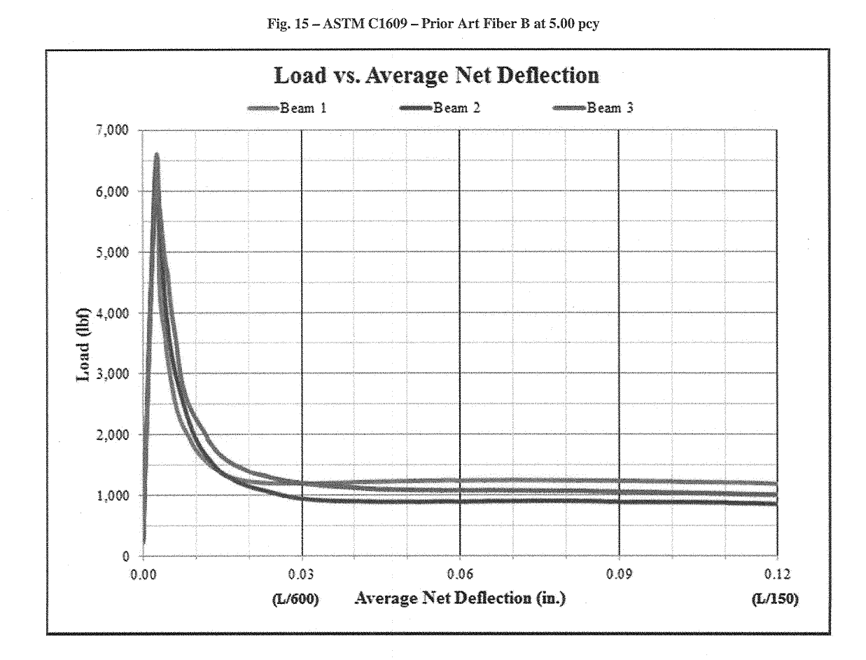

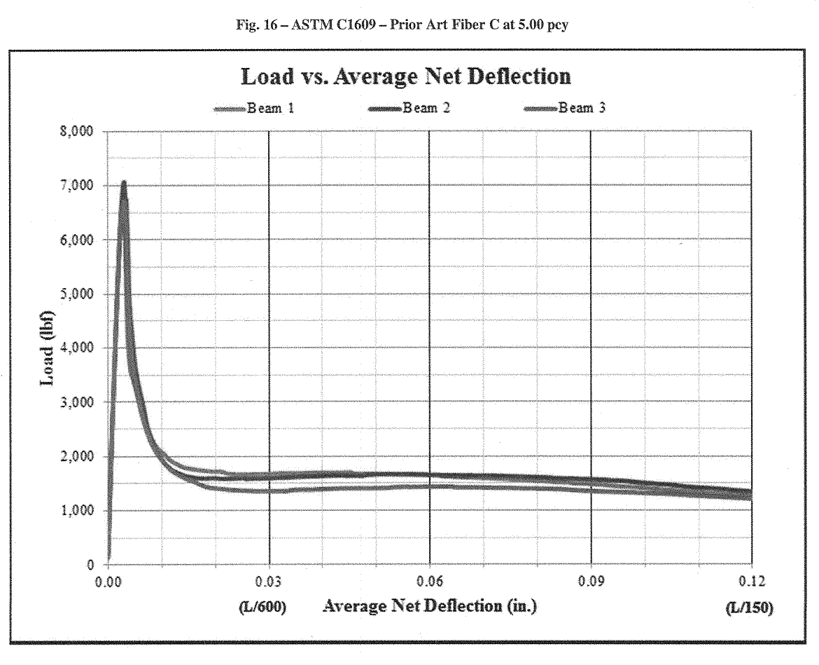

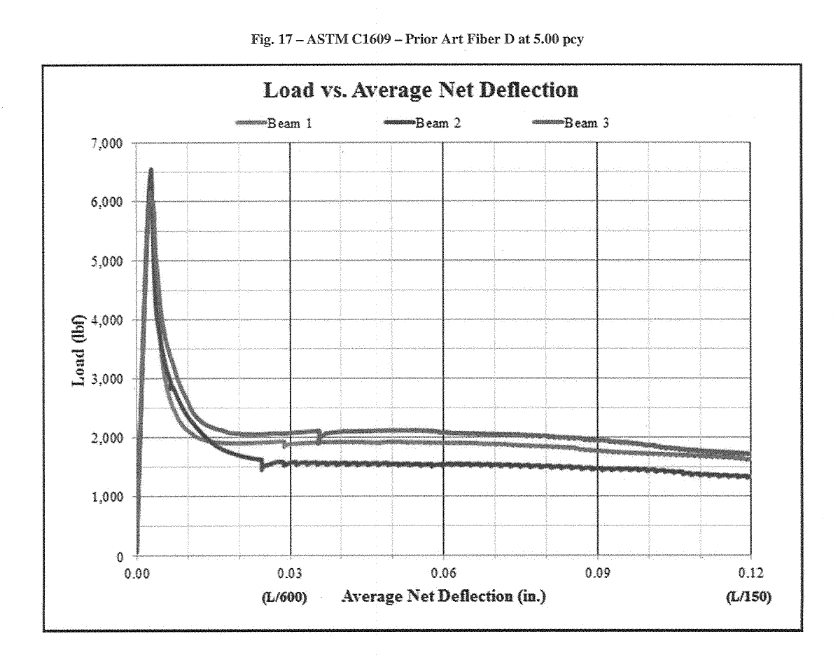

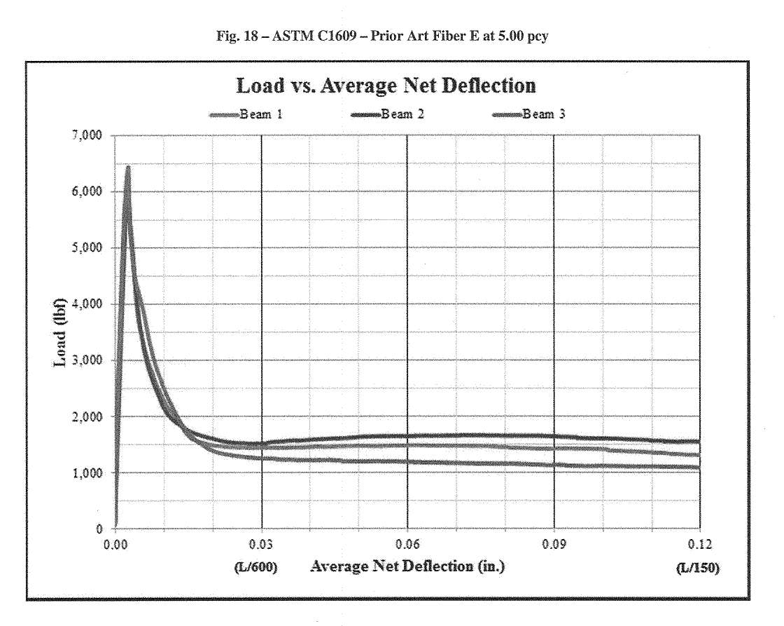

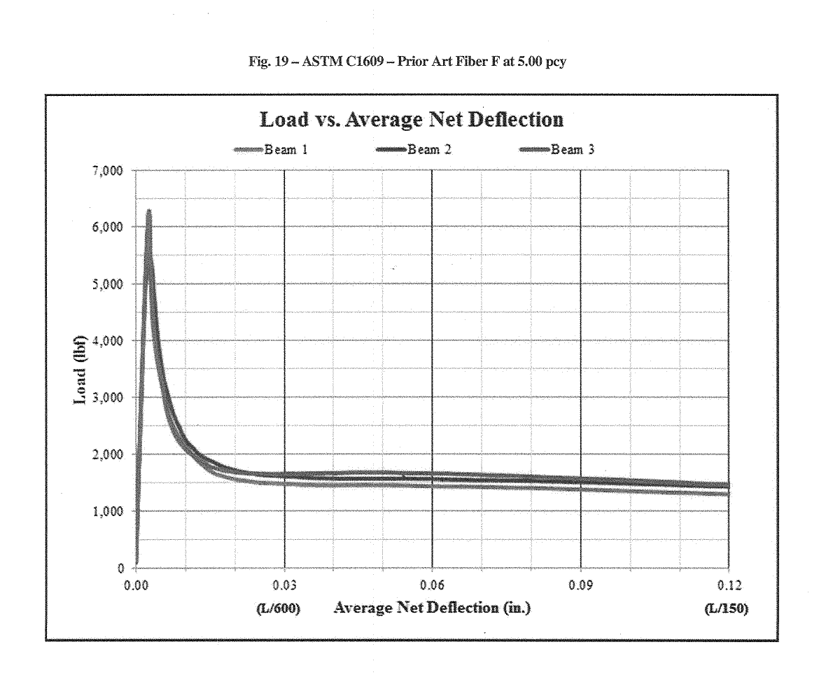

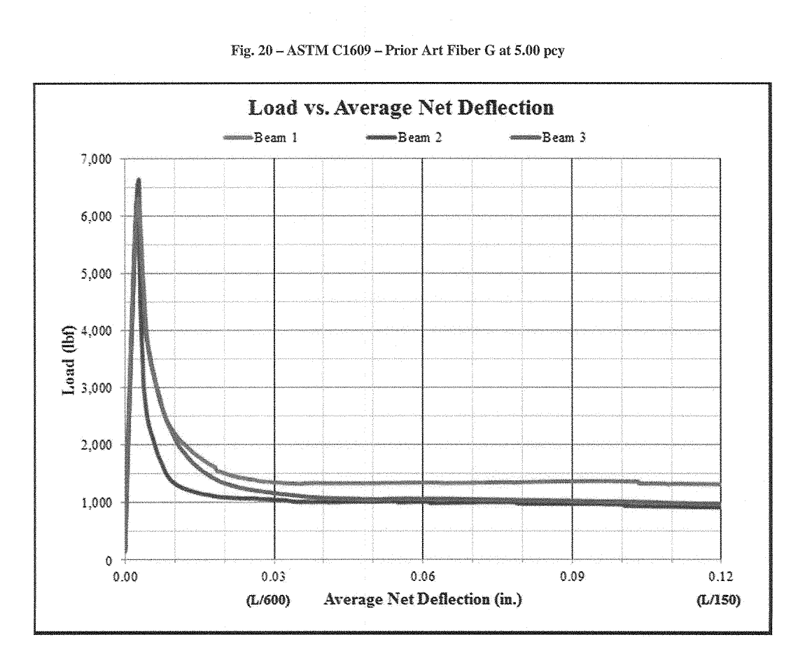

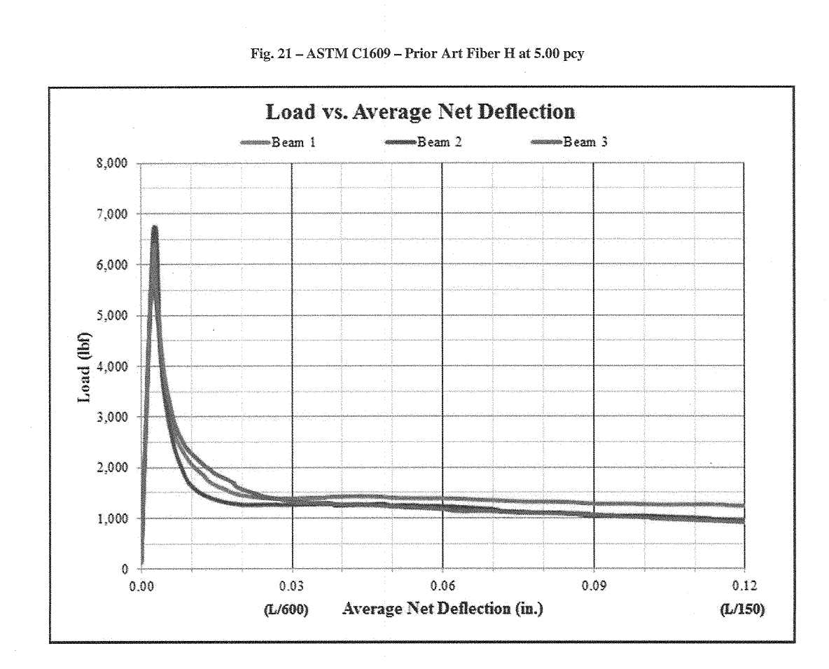

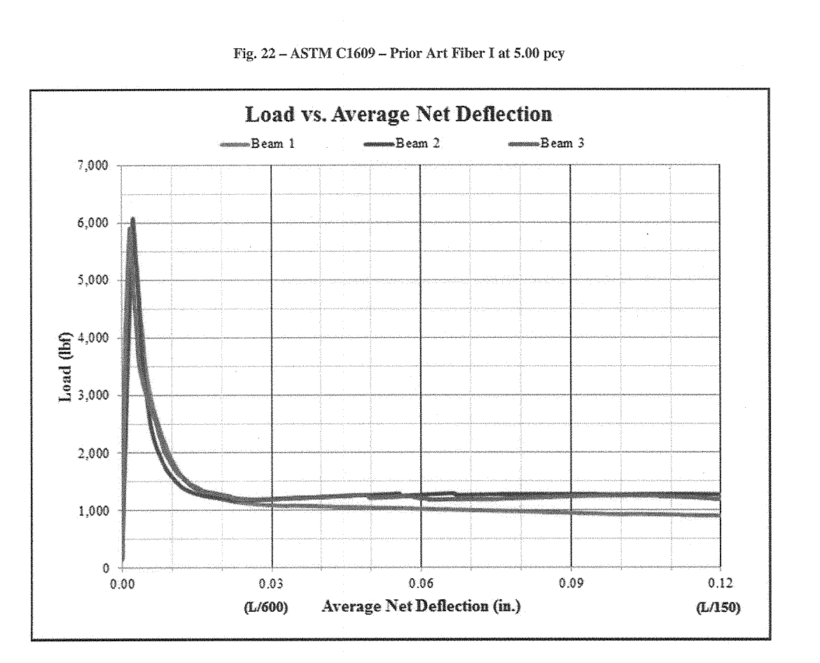

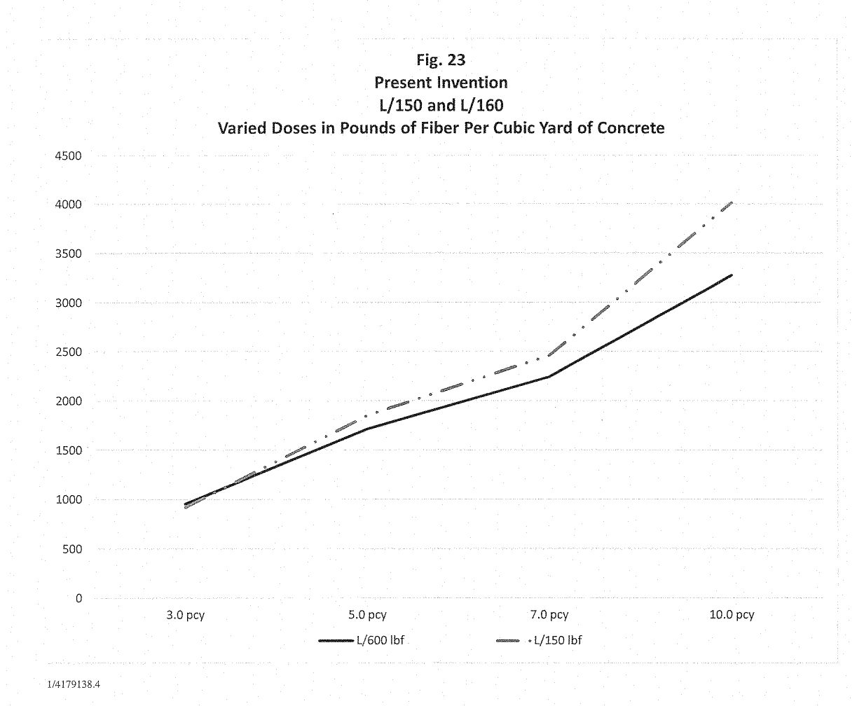

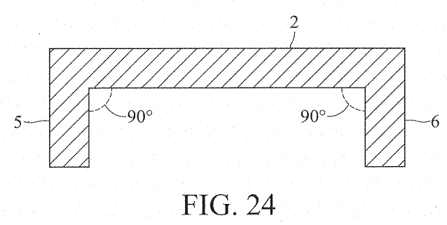

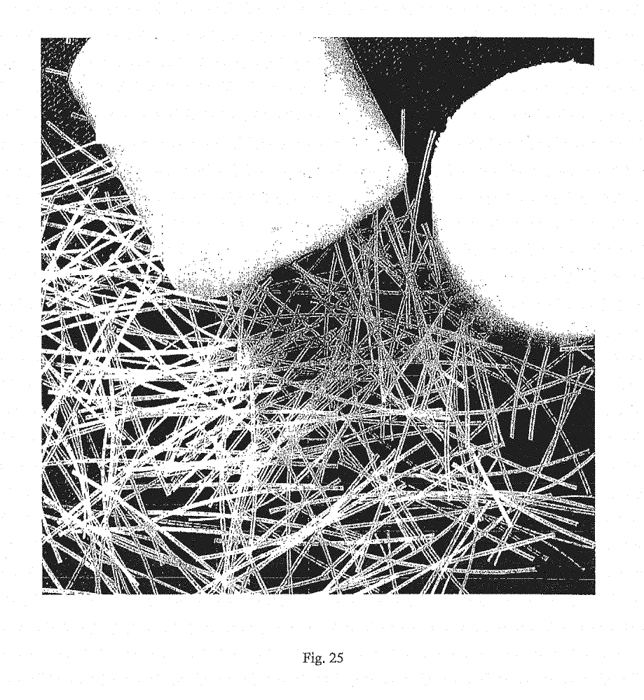

As shown in the scoring tool 23, or texturizer, in FIG. 8, one side of the extruded fiber is scored to produce indentions. The scoring may also be on the side of the fiber opposite what is shown. The shape of the scoring tool may be rectangular in one embodiment but it can vary. In the embodiment shown in FIG. 7, the length of the indentations is approximately 0.0315 inches (0.0137 mm). The depth in this embodiment is approximately 0.040 inches. In one embodiment, the depth of the scoring is about one third of the wall shown in the embodiment in FIG. 7, although this depiction is not to scale. The scoring shown in FIG. 6 shows the approximate location of the indentions in one embodiment but FIG. 6 is not to scale showing the depth of the indentions. The percentage of scored surface of the extruded fiber may be within a range of 30 to 70%.

In another embodiment of the fiber, as shown in FIG. 24, each border C, D of the central panel 2 is integral directly with one of the walls 5, 6 so that there is no area of joinder present. The cross-section of the walls may embody any of a number of shapes which project to either side or to both sides of the central panel, so that this embodiment may have the cross-section of the U-shape or the H-shape.

As shown generally in FIG. 5A where the central panel axis 35 is intersected on either end by a wall axis X, so that the wall axes (and the walls themselves) extend beyond planes A and B of the central panel. Wall axes X represent the general orientation of a wall which intersects central panel axis 35, as long as each wall comprises a shape which reduces or inhibits the forces expressed in Poisson's Ratio. The angles at which wall axes X intersect central panel axis 35 may vary.

The invention has demonstrated unexpected results in testing to evaluate its performance at dosages of 3.00, 5.00, 7.00 & 10.0 pounds per cubic yard of concrete (hereinafter “PCY”) in a typical slab concrete mix with a compressive strength of 4,000-5,000 psi at an age of 7 days. The concrete was batched and mixed in accordance with ASTM C192-15 Standard Practice for Making and Curing Concrete Test Specimens in the Laboratory, which standard is incorporated herein in its entirety. The fibers were added at the beginning of the batch sequence and mixed with the rock and sand for 1 minute prior to the addition of the cementitious material. The concrete was then mixed for 3 minutes, allowed to rest for 3 minutes, and mixed for 2 additional minutes. Plastic properties were then determined and recorded in accordance with the applicable standards. Three 6″×6″×20″ beams were cast for testing in accordance with ASTM C1609/C1609M-12 Standard Test Method for Flexural Performance of Fiber-Reinforced Concrete (Using Beam With Third-Point Loading), which standard is also incorporated herein in its entirety. Three 6″×12″ cylinders were also cast for compressive strength determination. Mix proportions, plastic, and hardened properties are reported in Table 1:

TABLE 1
Concrete Mix Design and Properties

| | | | Mix 1 | | Mix 2 | | Mix 3 | | Mix 4 | |
|---|---|---|---|---|---|---|---|---|---|---|
| | | | Weight | Vol. | Weight | Vol. | Weight | Vol. | Weight | Vol. |
| ASTM | Classification | Source | (pcy) | (ft³) | (pcy) | (ft³) | (pcy) | (ft³) | (pcy) | (ft³) |
| C150 | Type I/II | Lehigh - Leeds, AL | 675 | 3.43 | 675 | 3.43 | 675 | 3.43 | 675 | 3.43 |
| | Cement | | | | | | | | | |
| C33 | Natural Sand | Lambert Sand Co. | 1241 | 7.56 | 1237 | 7.54 | 1231 | 7.50 | 1223 | 7.45 |
| C33 | #57 Stone - | Vulcan - Lithonia, | 1630 | 9.96 | 1630 | 9.96 | 1630 | 9.96 | 1630 | 9.96 |
| | Granite | GA | | | | | | | | |
| C94 | Water - Potable | Lawrenceville, GA | 340 | 5.45 | 340 | 5.45 | 340 | 5.45 | 340 | 5.45 |
| | | w/c Ratio | 0.504 | | 0.504 | | 0.504 | | 0.504 | |
| C1116 | Synthetic Fiber | Omni HP | 3.00 | 0.05 | 5.00 | 0.08 | 7.00 | 0.11 | 10.00 | 0.16 |
| C192 | Design Air | 2.00% | NA | 0.54 | NA | 0.54 | NA | 0.54 | NA | 0.54 |
| | Content | | | | | | | | | |
| Totals | | | 3889 | 27.00 | 3887 | 27.00 | 3883 | 27.00 | 3878 | 27.00 |
| C143 | Slump (in.) | After Fiber Addition | 6.00 | | 5.00 | | 4.00 | | 2.50 | |
| C231 | Air Content (%) | After Fiber Addition | 1.5 | | 1.4 | | 1.5 | | 1.6 | |
| C138 | Unit Weight | After Fiber Addition | 145.0 | | 145.0 | | 145.1 | | 144.9 | |
| | (pcf) | | | | | | | | | |
| C1064 | Concrete Temperature ° F. | | 75.0 | | 74.0 | | 74.0 | | 77.0 | |
| C1064 | Air Temperature ° F. | | 74.0 | | 76.0 | | 72.0 | | 77.0 | |
| C39 | Compressive | 7 days | 4,280 | 4,470 | 4,750 | 4,830 | 4,350 | 4,220 | 4,230 | 4,180 |
| | Strength (psi) | | 4,640 | | 4,880 | | 4,100 | | 3,960 | |
| | 6″ × 12″ | | 4,490 | | 4,850 | | 4,220 | | 4,350 | |
| | Cylinders | | | | | | | | | |

Concrete comprises a mixture of sand and larger crushed rock in various sizes. The concrete mix used to evaluate the performance of the present invention consisted of cement, coarse aggregate, natural sand and water without admixtures or additives. The coarse aggregate was a size #57 (max top size 1.5″) and the sand was a concrete sand (⅜″ to zero). The cement was a Portland cement Type I and the water was potable. The proportions of the mix and the cement content were typical for a 4,000 psi compressive strength target at 28 days. Additional details about the mix are set forth in Table 1. The present invention's improvement in performance of the mix identified, however, is not limited to the mix in Table 1, but it will perform in a similar fashion for other types of mix as well, including those containing admixtures and additives.

Casting of the beam specimens was performed by discharging the concrete directly from the wheel barrow into the mold and filling to a height of approximately 1-2 inches above the rim. The 6″×12″ cylinder molds were filled using a scoop to a height of approximately 1-2 inches above the rim of the mold. Both the beam and cylinder specimens were then consolidated by means of an external vibrating table at a frequency of 60 Hz. The consolidation was determined to be adequate once the mortar contacted all of the interior edges, as well as the corners of the mold, and no voids greater than ⅛″ diameter were observed. Care was taken to ensure that all specimens were vibrated for the same duration of time and in concurrent sets. The specimens were then finished with an aluminum trowel and moved to a level surface. Specimens were covered with wet burlap and plastic in a manner as to not disturb the surface finish and prevent moisture loss. After curing in the mold for 24 hours the hardened specimens were removed from the molds and placed in a saturated lime bath at 73±3.5° F. until the time of testing.

Three beams specimens were tested per ASTMC 1609 at an 18″ span length using roller supports meeting the requirements of ASTM C1812-15 Standard Practice for Design of Journal Bearing Supports to be Used in Fiber Reinforced Concrete Beam Tests, which standard is hereby incorporated herein in its entirety. The test machine used was a Satec-Model 5590-HVL closed-loop, dynamic servo-hydraulic, testing machine conforming to the requirements of ASTM E4-14 Standard Practices for Force Verification of Testing Machines, which standard is hereby incorporated herein in its entirety. Load and deflection data were collected electronically at a frequency of 5 Hertz. The load was applied perpendicular to the molded surfaces after the edges were ground with a rubbing stone. Net deflection values, for both data acquisition and rate control, were obtained at the mid-span and mid-height of the beams. The rate of loading was held constant at 0.002 in/min of average net deflection for the entire duration of each test.

The testing uses third point loading, the two rockers in contact with the top side of the beam apply the load. The crack will appear at the mid-span of the beam. In this test closed-loop loading was employed. Instead of loading the beam at a constant rate per time increment, the beam was loaded based on the deflection of the beam. The point of L/600 first was reached and then L/150 thereafter. Measurements of deflection were made from the harness at the mid height of the beam. The standard beam is 6″×6″×20″ and the clear span length (between the rockers in contact with the bottom of the beam) was 18″. Tests were conducted at 7 days after casting.

In testing there was an unexpected beneficial anomaly found in the ASTM C1609 data. The load carrying results at the L/150 deflection were higher than the results for the lower deflection data at L/600. In the part of the program where the invention was compared to prior art products at 5.0 pcy, only the invention showed an increase in load carrying capability at the higher deflection, L/150. A summary of test results for the present invention fiber at doses of 3.0, 5.0, 7.0 and 10.0 pounds per cubic yard (pcy) are set forth in Table 2:

TABLE 2
ASTM C1609 - Summary Test Results - 7 days

| | | Present Invention | | | |
|---|---|---|---|---|---|
| | | Dosage (pcy) | | | |
| Fiber Designation | | 3.00 | 5.00 | 7.00 | 10.00 |
| Specimen | Width (in.) | 6.05 | 6.00 | 6.00 | 6.05 |
| Dimension | Depth (in.) | 6.00 | 6.00 | 5.95 | 6.00 |
| Initial | 8₁ - Deflection at First Crack (in.) | 0.0025 | 0.0024 | 0.0026 | 0.0026 |
| Deflections | 8_{P} - Deflection at Peak Load (in.) | 0.0027 | 0.0026 | 0.0028 | 0.0028 |
| Loads | P₁ - First Crack Load (lbf.) | 6,736 | 6,536 | 6,207 | 6,508 |
| | P - Peak Load (lbf.) | 6,963 | 6,782 | 6,299 | 6,645 |
| | P₆₀₀¹⁵⁰ - Load at L/600 (lbf.) | 951 | 1,714 | 2,241 | 3,272 |
| | P₁₅₀¹⁵⁰ - Load at L/150 (lbf.) | 919 | 1,831 | 2,461 | 4,013 |
| Stress | f₁ - First Crack Stress (psi) | 555 | 550 | 520 | 535 |
| | f_{P} - Peak Stress (psi) | 575 | 570 | 530 | 545 |
| | f₆₀₀¹⁵⁰ - Stress at L/600 (psi) | 80 | 145 | 190 | 270 |
| | f₁₅₀¹⁵⁰ - Stress at L/150 (psi) | 75 | 155 | 205 | 330 |
| Toughness | T₁₅₀¹⁵⁰ - Toughness (in-lbs) | 140 | 237 | 307 | 450 |
| | f_{T,150}¹⁵⁰ or Fe_{3 mm} (psi) | 96 | 166 | 215 | 307 |
| | R_{T,150}¹⁵⁰ or Re₃ (%) | 17.5 | 30.1 | 41.3 | 57.8 |

Table 2 contains averages of results for each dose of the present invention fiber, and all the data for each dose is shown in Tables 3-6 below:

TABLE 3
ASTM C1609 - Present Invention at 3.00 pcy - 7 days

| Specimen ID | | 1 | 2 | 3 | Avg |
|---|---|---|---|---|---|
| Specimen | Width (in.) | 6.05 | 6.00 | 6.05 | 6.05 |
| Dimensions | Depth (in.) | 6.05 | 6.00 | 6.00 | 6.00 |
| Initial | Deflection at First Crack | 0.0024 | 0.0024 | 0.0027 | 0.0025 |
| | (in.) | | | | |
| Deflections | Deflection at Peak Load | 0.0028 | 0.0026 | 0.0028 | 0.0027 |
| | (in.) | | | | |
| Loads | First Crack Load (lbf.) | 6,779 | 6,106 | 7,322 | 6,736 |
| | Peak Load (lbf.) | 7,155 | 6,282 | 7,451 | 6,963 |
| | Load at L/600 (lbf.) | 963 | 965 | 926 | 951 |
| | Load at L/150 (lbf.) | 993 | 977 | 786 | 919 |
| Stress | First Crack Stress (psi) | 550 | 510 | 605 | 555 |
| | Peak Stress (psi) | 580 | 525 | 615 | 575 |
| | Stress at L/600 (psi) | 80 | 80 | 75 | 80 |
| | Stress at L/150 (psi) | 80 | 80 | 65 | 75 |
| Toughness | Toughness (in-lbs) | 150 | 140 | 130 | 140 |
| | or, (psi) | 102 | 97 | 90 | 96 |
| | or, (%) | 18.5 | 19.0 | 14.9 | 17.5 |

TABLE 4
ASTM C1609 Present Invention at 5.00 pcy - 7 days

| Specimen ID | | 1 | 2 | 3 | Avg |
|---|---|---|---|---|---|
| Specimen | Width (in.) | 6.00 | 5.95 | 6.00 | 6.00 |
| Dimensions | Depth (in.) | 5.95 | 6.00 | 6.00 | 6.00 |
| Initial | Deflection at First Crack | 0.0020 | 0.0027 | 0.0024 | 0.0024 |
| Deflections | (in.) | | | | |
| | Deflection at Peak Load | 0.0023 | 0.0028 | 0.0027 | 0.0026 |
| | (in.) | | | | |
| Loads | First Crack Load (lbf.) | 6,472 | 7,058 | 6,079 | 6,536 |
| | Peak Load (lbf.) | 6,770 | 7,129 | 6,446 | 6,782 |
| | Load at L/600 (lbf.) | 1,703 | 1,920 | 1,518 | 1,714 |
| | Load at L/150 (lbf.) | 1,940 | 2,040 | 1,513 | 1,831 |
| Stress | First Crack Stress (psi) | 550 | 595 | 505 | 550 |
| | Peak Stress (psi) | 575 | 600 | 535 | 570 |
| | Stress at L/600 (psi) | 145 | 160 | 125 | 145 |
| | Stress at L/150 (psi) | 165 | 170 | 125 | 155 |
| Toughness | Toughness (in-lbs) | 240 | 260 | 210 | 237 |
| | or, (psi) | 169 | 182 | 146 | 166 |
| | or, (%) | 30.7 | 30.6 | 28.9 | 30.1 |

TABLE 5
ASTM C1609 - Present Invention at 7.00 pcy - 7 days

| Specimen ID | | 1 | 2 | 3 | Avg |
|---|---|---|---|---|---|
| Specimen | Width (in.) | 6.00 | 5.95 | 6.05 | 6.00 |
| Dimensions | Depth (in.) | 5.95 | 5.95 | 6.00 | 5.95 |
| Initial | Deflection at First Crack (in.) | 0.0027 | 0.0024 | 0.0026 | 0.0026 |
| Deflections | Deflection at Peak Load (in.) | 0.0027 | 0.0028 | 0.0030 | 0.0028 |
| Loads | First Crack Load (lbf.) | 6,503 | 5,919 | 6,199 | 6,207 |
| | Peak Load (lbf.) | 6,520 | 6,090 | 6,287 | 6,299 |
| | Load at L/600 (lbf.) | 2,158 | 2,241 | 2,324 | 2,241 |
| | Load at L/150 (lbf.) | 2,499 | 2,347 | 2,538 | 2,461 |
| Stress | First Crack Stress (psi) | 550 | 505 | 510 | 520 |
| | Peak Stress (psi) | 550 | 520 | 520 | 530 |
| | Stress at L/600 (psi) | 185 | 190 | 190 | 190 |
| | Stress at L/150 (psi) | 210 | 200 | 210 | 205 |
| Toughness | Toughness (in-lbs) | 300 | 300 | 320 | 307 |
| | or, (psi) | 212 | 214 | 220 | 215 |
| | or, (%) | 38.5 | 42.4 | 43.1 | 41.3 |

TABLE 6
ASTM C1609 - Present Invention at 10.00 pcy - 7 days

| Specimen ID | | 1 | 2 | 3 | Avg |
|---|---|---|---|---|---|
| Specimen | Width (in.) | 6.05 | 6.10 | 6.05 | 6.05 |
| Dimensions | Depth (in.) | 6.00 | 6.00 | 6.05 | 6.00 |
| Initial | Deflection at First Crack | 0.0027 | 0.0023 | 0.0028 | 0.0026 |
| Deflections | (in.) | | | | |
| | Deflection at Peak Load (in.) | 0.0029 | 0.0026 | 0.0029 | 0.0028 |
| Loads | First Crack Load (lbf.) | 6,763 | 5,758 | 7,004 | 6,508 |
| | Peak Load (lbf.) | 6,907 | 5,968 | 7,059 | 6,645 |
| | Load at L/600 (lbf.) | 3,362 | 2,990 | 3,463 | 3,272 |
| | Load at L/150 (lbf.) | 4,268 | 3,583 | 4,187 | 4,013 |
| Stress | First Crack Stress (psi) | 560 | 470 | 570 | 535 |
| | Peak Stress (psi) | 570 | 490 | 575 | 545 |
| | Stress at L/600 (psi) | 280 | 245 | 280 | 270 |
| | Stress at L/150 (psi) | 355 | 295 | 340 | 330 |
| Toughness | Toughness (in-lbs) | 470 | 410 | 470 | 450 |
| | or, (psi) | 324 | 280 | 318 | 307 |
| | or, (%) | 57.9 | 59.6 | 55.8 | 57.8 |

The fibers of the present invention continued to hold their original shape and did not de-bond from the hardened concrete. Thus, the unique configuration of the invention provides superior performance when compared to prior art products utilizing a consensus standard test method, ASTM C1609.

In the C1609 graphs presented and discussed herein for the present invention fibers, the peak load at the point of first crack of the beam was around 7,250 lbf. The load carried by the fibers after first crack was in the neighborhood of 1,750 lbf for 3 pcy and 2,250 lbs for 5 pcy. For the Re₃ numbers in Table 2 the basic residual strength was 17.5% for 3.0 pcy and 30.1% for 5.0 pcy. These numbers show the quantity, in percentages the fibers are capable of supporting in respect to the first-crack load of the beam.

The dosage level of the macrosynthetic fibers has a direct bearing on the data generated. Round robin testing conducted by ASTM Subcommitee Co9.42 has determined that the accuracy of the test decreases as the quantity of fiber decreases. As the dosage rate decreases the standard deviation and CoV (Coefficient of Variation) increase. Thus the validity of the test is compromised when the dosage level of fiber in the beams is below 3 pcy. Thus 3 pcy is the borderline for obtaining accurate test data. As the dosage rate increases above 3 pcy the L/150 value of the present invention accelerates over the L/600 value. This measured increase is unexpected. As the load is continued to be applied the deflection of the beam increases.

Prior art fibers A-I have also been critiqued in tests similar to those described above for the present invention fibers. As a result of their unique configuration and properties, when the present invention fibers are mixed in concrete which is hardened, bonding of the fibers is increased, the modulus of elasticity is increased and the Poisson's Ratio is decreased compared to hardened concrete containing the prior art fibers. Support for this conclusion includes, without limitation, the data for ASTM standard C39 testing for compressive strength as shown in Table 7

With prior art fibers A-I, as the deflection of the beam increases more of the fibers become less effective by either de-bonding or breaking at the crack, as summarized in Tables 7 and 8, and as depicted in FIG. 13.

### Table 7—Concrete Mix Design and Properties

TABLE 7
Concrete Mix Design and Properties

| Source | | Applicant | A | B | C | D | E | F | G | H | I |
|---|---|---|---|---|---|---|---|---|---|---|---|
| | Material \| | Mix 1 | Mix 2 | Mix 3 | Mix 4 | Mix 5 | Mix 6 | Mix 7 | Mix 8 | Mix 9 | Mix 10 |
| ASTM | Source | (pcy) | (pcy) | (pcy) | (pcy) | (pcy) | (pcy) | (pcy) | (pcy) | (pcy) | (pcy) |
| C150 | Type I/II | 675 | 675 | 675 | 675 | 675 | 675 | 675 | 675 | 675 | 675 |
| | Cement | | | | | | | | | | |
| | Lehigh | | | | | | | | | | |
| | Leeds, AL | | | | | | | | | | |
| C33 | Natural | 1237 | 1237 | 1237 | 1237 | 1237 | 1237 | 1237 | 1237 | 1237 | 1237 |
| | Sand | | | | | | | | | | |
| | Lambert | | | | | | | | | | |
| | Sand Co. | | | | | | | | | | |
| C33 | #57 Stone | 1630 | 1630 | 1630 | 1630 | 1630 | 1630 | 1630 | 1630 | 1630 | 1630 |
| | Granite | | | | | | | | | | |
| | Vulcan | | | | | | | | | | |
| | Lithonia, | | | | | | | | | | |
| | GA | | | | | | | | | | |
| C94 | Water | 340 | 340 | 340 | 340 | 340 | 340 | 340 | 340 | 340 | 340 |
| | Potable | | | | | | | | | | |
| | Lawrenceville, | | | | | | | | | | |
| | GA | | | | | | | | | | |
| | w/c Ratio | 0.504 | 0.504 | 0.504 | 0.504 | 0.504 | 0.504 | 0.504 | 0.504 | 0.504 | 0.504 |
| C1116 | Synthetic | 5.00 | 5.00 | 5.00 | 5.00 | 5.00 | 5.00 | 5.00 | 5.00 | 5.00 | 5.00 |
| | Fiber | | | | | | | | | | |
| | Various | | | | | | | | | | |
| C192 | Design Air | NA | NA | NA | NA | NA | NA | NA | NA | NA | NA |
| | Content | | | | | | | | | | |
| | 2.00% | | | | | | | | | | |
| Totals | | 3887 | 3887 | 3887 | 3887 | 3887 | 3887 | 3887 | 3887 | 3887 | 3887 |
| C143 | Slump (in.) | 6.00 | 6.75 | 5.75 | 3.75 | 6.00 | 4.00 | 4.00 | 6.50 | 5.50 | 5.75 |
| C231 | Air Content | 1.5 | 1.4 | 1.6 | 1.4 | 1.5 | 1.5 | 1.5 | 1.4 | 1.3 | 1.7 |
| | (%) | | | | | | | | | | |
| C138 | Unit Weight | 145.0 | 145.4 | 145.2 | 145.6 | 145.2 | 145.2 | 145.2 | 145.6 | 145.6 | 145.0 |
| | (pcf) | | | | | | | | | | |
| C1064 | Concrete | 75.0 | 77.0 | 76.0 | 75.0 | 78.0 | 72.0 | 72.0 | 74.0 | 74.0 | 72.0 |
| | Temp ° F. | | | | | | | | | | |
| C1064 | Air Temp ° F. | 74.0 | 78.0 | 76.0 | 72.0 | 78.0 | 72.0 | 72.0 | 72.0 | 74.0 | 72.0 |
| C39 | Compressive | 4,750 | 4,530 | 3,950 | 4,320 | 4,540 | 4,680 | 4,100 | 4,250 | 4,060 | 3,850 |
| | Strength (psi) | 4,880 | 4,320 | 4,050 | 4,690 | 4,250 | 4,970 | 4,160 | 4,260 | 3,820 | 3,750 |
| | 6″ × 12″ | 4,850 | 4,700 | 4,150 | 4,500 | 4,310 | 5,110 | 4,270 | 4,090 | 3,830 | 3,700 |
| | Average | 4,830 | 4,520 | 4,050 | 4,500 | 4,370 | 4,920 | 4,180 | 4,200 | 3,900 | 3,770 |

TABLE 8
ASTM C1609 - Summary Test Results

| Source | Applicant | A | B | C | D |
|---|---|---|---|---|---|
| Width (in.) | 6.00 | 5.90 | 6.00 | 6.10 | 6.00 |
| Depth (in.) | 6.00 | 5.95 | 6.00 | 6.00 | 5.95 |
| 81 - Deflection | 0.0024 | 0.0025 | 0.0024 | 0.0023 | 0.0025 |
| at First Crack | | | | | |
| (in.) | | | | | |
| 8P - | 0.0026 | 0.0030 | 0.0027 | 0.0030 | 0.0028 |
| Deflection at | | | | | |
| Peak Load | | | | | |
| (in.) | | | | | |
| P1 - First | 6,536 | 6,362 | 6,236 | 6,073 | 6,063 |
| Crack Load | | | | | |
| (lbf.) | | | | | |
| PP - Peak | 6,782 | 6,690 | 6,439 | 6,852 | 6,373 |
| Load (lbf.) | | | | | |
| P150 - Load at | 1,714 | 1,533 | 1,118 | 1,542 | 1,846 |
| L/600 (lbf.) | | | | | |
| 600 | | | | | |
| P150 - Load at | 1,831 | 1,428 | 1,016 | 1,272 | 1,567 |
| L/150 (lbf.) | | | | | |
| 150 | | | | | |
| fl - First | 550 | 550 | 525 | 495 | 515 |
| Crack Stress | | | | | |
| (psi) | | | | | |
| fP - Peak | 570 | 580 | 540 | 565 | 540 |
| Stress (psi) | | | | | |
| f150 - Stress at | 145 | 130 | 95 | 130 | 155 |
| L/600 (psi) | | | | | |
| 600 | | | | | |
| f150 - Stress at | 155 | 125 | 85 | 105 | 130 |
| L/150 (psi) 150 | | | | | |
| T150 - | 237 | 207 | 157 | 203 | 233 |
| Toughness (in- | | | | | |
| lbs) 150 | | | | | |
| f150 or Fe (psi) | 166 | 149 | 110 | 139 | 164 |
| T,150 3 mm | | | | | |
| R150 or Re | 30.1 | 27.1 | 20.9 | 28.1 | 32.2 |
| (%) T,150 | | | | | |
| 3 mm | | | | | |
| Source | E | F | G | H | I |
| Width (in.) | 5.95 | 5.95 | 5.90 | 6.00 | 5.95 |
| Depth (in.) | 5.95 | 5.95 | 5.95 | 6.00 | 6.00 |
| 81 - Deflection | 0.0022 | 0.0024 | 0.0023 | 0.0024 | 0.0020 |
| at First Crack | | | | | |
| (in.) | | | | | |
| 8P - | 0.0026 | 0.0026 | 0.0027 | 0.0026 | 0.0021 |
| Deflection at | | | | | |
| Peak Load | | | | | |
| (in.) | | | | | |
| P1 - First | 5,892 | 5,885 | 6,178 | 6,369 | 5,270 |
| Crack Load | | | | | |
| (lbf.) | | | | | |
| PP - Peak | 6,164 | 6,098 | 6,510 | 6,484 | 5,971 |
| Load (lbf.) | | | | | |
| P150 - Load at | 1,405 | 1,584 | 1,189 | 1,322 | 1,215 |
| L/600 (lbf.) | | | | | |
| 600 | | | | | |
| P150 - Load at | 1,319 | 1,404 | 1,071 | 1,031 | 1,219 |
| L/150 (lbf.) | | | | | |
| 150 | | | | | |
| fl - First | 500 | 495 | 530 | 530 | 475 |
| Crack Stress | | | | | |
| (psi) | | | | | |
| fP - Peak | 525 | 515 | 555 | 540 | 490 |
| Stress (psi) | | | | | |
| f150 - Stress at | 120 | 135 | 100 | 110 | 105 |
| L/600 (psi) | | | | | |
| 600 | | | | | |
| f150 - Stress at | 110 | 120 | 95 | 85 | 105 |
| L/150 (psi) 150 | | | | | |
| T150 - | 193 | 203 | 163 | 170 | 160 |
| Toughness (in- | | | | | |
| lbs) 150 | | | | | |
| f150 or Fe (psi) | 137 | 143 | 117 | 118 | 112 |
| T,150 3 mm | | | | | |
| R150 or Re | 27.4 | 28.9 | 22.0 | 22.3 | 23.5 |
| (%) T,150 | | | | | |
| 3 mm | | | | | |

Full test results for prior art fibers A-I (names and manufacturers recorded in the test report) are presented in Tables 9-17 below:

TABLE 9
ASTM C1609 - Prior Art Fiber A at 5.00 pcy - 7 days

| Specimen ID | | 1 | 2 | 3 | Avg |
|---|---|---|---|---|---|
| Specimen | Width (in.) | 5.90 | 5.90 | 5.95 | 5.90 |
| Dimension | Depth (in.) | 5.90 | 5.90 | 6.00 | 5.95 |
| Initial | 8₁ - Deflection at First Crack (in.) | 0.0024 | 0.0025 | 0.0026 | 0.0025 |
| Deflections | 8_{P} - Deflection at Peak Load (in.) | 0.0028 | 0.0029 | 0.0032 | 0.0030 |
| Loads | P₁ - First Crack Load (lbf.) | 6,087 | 6,366 | 6,632 | 6,362 |
| | P - Peak Load (lbf.) | 6,343 | 6,792 | 6,936 | 6,690 |
| | P₆₀₀¹⁵⁰ - Load at L/600 (lbf.) | 1,543 | 1,607 | 1,448 | 1,533 |
| | P₁₅₀¹⁵⁰ - Load at L/150 (lbf.) | 1,535 | 1,274 | 1,475 | 1,428 |
| Stress | f₁ - First Crack Stress (psi) | 535 | 560 | 555 | 550 |
| | f_{P} - Peak Stress (psi) | 555 | 595 | 585 | 580 |
| | f₆₀₀¹⁵⁰ - Stress at L/600 (psi) | 135 | 140 | 120 | 130 |
| | f₁₅₀¹⁵⁰ - Stress at L/150 (psi) | 135 | 110 | 125 | 125 |
| Toughness | T₁₅₀¹⁵⁰ - Toughness (in-lbs) | 220 | 200 | 200 | 207 |
| | f_{T,150}¹⁵⁰ or Fe_{3 mm} (psi) | 161 | 146 | 140 | 149 |
| | R_{T,150}¹⁵⁰ or Re_{3 mm} (%) | 30.1 | 26.1 | 25.2 | 27.1 |

TABLE 10
ASTM C1609 - Prior Art Fiber B at 5.00 pcy

| Specimen ID | | 1 | 2 | 3 | Avg |
|---|---|---|---|---|---|
| Specimen | Width (in.) | 6.05 | 6.00 | 5.90 | 6.00 |
| Dimension | Depth (in.) | 6.00 | 6.00 | 5.95 | 6.00 |
| Initial | 8₁ - Deflection at First Crack (in.) | 0.0023 | 0.0024 | 0.0025 | 0.0024 |
| Deflections | 8_{P} - Deflection at Peak Load (in.) | 0.0027 | 0.0027 | 0.0028 | 0.0027 |
| Loads | P₁ - First Crack Load (lbf.) | 6,319 | 6,005 | 6,385 | 6,236 |
| | P - Peak Load (lbf.) | 6,605 | 6,151 | 6,562 | 6,439 |
| | P₆₀₀¹⁵⁰ - Load at L/600 (lbf.) | 1,196 | 947 | 1,210 | 1,118 |
| | P₁₅₀¹⁵⁰ - Load at L/150 (lbf.) | 1,187 | 855 | 1,005 | 1,016 |
| Stress | f₁ - First Crack Stress (psi) | 520 | 500 | 550 | 525 |
| | f_{P} - Peak Stress (psi) | 545 | 515 | 565 | 540 |
| | f₆₀₀¹⁵⁰ - Stress at L/600 (psi) | 100 | 80 | 105 | 95 |
| | f₁₅₀¹⁵⁰ - Stress at L/150 (psi) | 100 | 70 | 85 | 85 |
| Toughness | T₁₅₀¹⁵⁰ - Toughness (in-lbs) | 170 | 140 | 160 | 157 |
| | f_{T,150}¹⁵⁰ or Fe_{3 mm} (psi) | 117 | 97 | 115 | 110 |
| | R_{T,150}¹⁵⁰ or Re_{3 mm} (%) | 22.5 | 19.4 | 20.9 | 20.9 |

TABLE 11
ASTM C1609 - Prior Art Fiber C at 5.00 pcy

| Specimen ID | | 1 | 2 | 3 | Avg |
|---|---|---|---|---|---|
| Specimen | Width (in.) | 6.30 | 6.00 | 6.00 | 6.10 |
| Dimension | Depth (in.) | 6.00 | 6.00 | 6.00 | 6.00 |
| Initial | 8₁ - Deflection at First Crack (in.) | 0.0023 | 0.0021 | 0.0025 | 0.0023 |
| Deflections | 8_{P} - Deflection at Peak Load (in.) | 0.0029 | 0.0031 | 0.0031 | 0.0030 |
| Loads | P₁ - First Crack Load (lbf.) | 6,016 | 5,768 | 6,436 | 6,073 |
| | P - Peak Load (lbf.) | 6,784 | 7,066 | 6,706 | 6,852 |
| | P₆₀₀¹⁵⁰ - Load at L/600 (lbf.) | 1,674 | 1,594 | 1,358 | 1,542 |
| | P₁₅₀¹⁵⁰ - Load at L/150 (lbf.) | 1,259 | 1,346 | 1,212 | 1,272 |
| Stress | f₁ - First Crack Stress (psi) | 475 | 480 | 535 | 495 |
| | f_{P} - Peak Stress (psi) | 540 | 590 | 560 | 565 |
| | f₆₀₀¹⁵⁰ - Stress at L/600 (psi) | 135 | 135 | 115 | 130 |
| | f₁₅₀¹⁵⁰ - Stress at L/150 (psi) | 100 | 110 | 100 | 105 |
| Toughness | T₁₅₀¹⁵⁰ - Toughness (in-lbs) | 210 | 210 | 190 | 203 |
| | f_{T,150}¹⁵⁰ or Fe_{3 mm} (psi) | 139 | 146 | 132 | 139 |
| | R_{T,150}¹⁵⁰ or Re₃ (%) | 29.3 | 30.4 | 24.7 | 28.1 |

TABLE 12
ASTM C1609 - Prior Art Fiber D at 5.00 pcy

| Specimen ID | | 1 | 2 | 3 | Avg |
|---|---|---|---|---|---|
| Specimen | Width (in.) | 6.05 | 5.90 | 6.00 | 6.00 |
| Dimensions | Depth (in.) | 6.00 | 5.90 | 6.00 | 5.95 |
| Initial | 8₁ - Deflection at First Crack (in.) | 0.0025 | 0.0026 | 0.0024 | 0.0025 |
| Deflections | 8_{P} - Deflection at Peak Load (in.) | 0.0028 | 0.0029 | 0.0028 | 0.0028 |
| Loads | P₁ - First Crack Load (lbf.) | 6,099 | 6,296 | 5,795 | 6,063 |
| | P - Peak Load (lbf.) | 6,423 | 6,546 | 6,151 | 6,373 |
| | P₆₀₀¹⁵⁰ - Load at L/600 (lbf.) | 1,887 | 1,575 | 2,076 | 1,846 |
| | P₁₅₀¹⁵⁰ - Load at L/150 (lbf.) | 1,632 | 1,340 | 1,729 | 1,567 |
| Stress | f₁ - First Crack Stress (psi) | 505 | 550 | 485 | 515 |
| | f_{P} - Peak Stress (psi) | 530 | 575 | 515 | 540 |
| | f₆₀₀¹⁵⁰ - Stress at L/600 (psi) | 155 | 140 | 175 | 155 |
| | f₁₅₀¹⁵⁰ - Stress at L/150 (psi) | 135 | 115 | 145 | 130 |
| Toughness | T₁₅₀¹⁵⁰ - Toughness (in-lbs) | 240 | 200 | 260 | 233 |
| | f_{T,150}¹⁵⁰ or Fe_{3 mm} (psi) | 165 | 146 | 181 | 164 |
| | R_{T,150}¹⁵⁰ or Re₃ (%) | 32.7 | 26.5 | 37.3 | 32.2 |

TABLE 13
ASTM C1609 - Prior Art Fiber D at 5.00 pcy

| Specimen ID | | 1 | 2 | 3 | Avg |
|---|---|---|---|---|---|
| Specimen | Width (in.) | 6.00 | 5.95 | 5.90 | 5.95 |
| Dimensions | Depth (in.) | 6.00 | 6.00 | 5.90 | 5.95 |
| Initial | 8₁ - Deflection at First Crack (in.) | 0.0020 | 0.0024 | 0.0023 | 0.0022 |
| Deflections | 8_{P} - Deflection at Peak Load (in.) | 0.0023 | 0.0028 | 0.0027 | 0.0026 |
| Loads | P₁ - First Crack Load (lbf.) | 5,736 | 5,821 | 6,120 | 5,892 |
| | P - Peak Load (lbf.) | 5,959 | 6,090 | 6,442 | 6,164 |
| | P₆₀₀¹⁵⁰ - Load at L/600 (lbf.) | 1,440 | 1,520 | 1,256 | 1,405 |
| | P₁₅₀¹⁵⁰ - Load at L/150 (lbf.) | 1,309 | 1,553 | 1,094 | 1,319 |
| Stress | f₁ - First Crack Stress (psi) | 480 | 490 | 535 | 500 |
| | f_{P} - Peak Stress (psi) | 495 | 510 | 565 | 525 |
| | f₆₀₀¹⁵⁰ - Stress at L/600 (psi) | 120 | 130 | 110 | 120 |
| | f₁₅₀¹⁵⁰ - Stress at L/150 (psi) | 110 | 130 | 95 | 110 |
| Toughness | T₁₅₀¹⁵⁰ - Toughness (in-lbs) | 200 | 210 | 170 | 193 |
| | f_{T,150}¹⁵⁰ or Re₃ (psi) | 139 | 147 | 124 | 137 |
| | R_{T,150}¹⁵⁰ or Re₃ (%) | 29.0 | 30.0 | 23.2 | 27.4 |

TABLE 14
ASTM C1609 - Prior Art Fiber F at 5.00 pcy

| Specimen ID | | 1 | 2 | 3 | Avg |
|---|---|---|---|---|---|
| Specimen | Width (in.) | 5.90 | 6.00 | 6.00 | 5.95 |
| Dimensions | Depth (in.) | 5.95 | 6.00 | 5.95 | 5.95 |
| Initial | 8₁ - Deflection at First Crack (in.) | 0.0023 | 0.0026 | 0.0023 | 0.0024 |
| Deflections | 8_{P} - Deflection at Peak Load (in.) | 0.0025 | 0.0026 | 0.0027 | 0.0026 |
| Loads | P₁ - First Crack Load (lbf.) | 5,594 | 6,253 | 5,807 | 5,885 |
| | P - Peak Load (lbf.) | 5,763 | 6,254 | 6,278 | 6,098 |
| | P₆₀₀¹⁵⁰ - Load at L/600 (lbf.) | 1,482 | 1,613 | 1,658 | 1,584 |
| | P₁₅₀¹⁵⁰ - Load at L/150 (lbf.) | 1,304 | 1,438 | 1,471 | 1,404 |
| Stress | f₁ - First Crack Stress (psi) | 480 | 520 | 490 | 495 |
| | f_{P} - Peak Stress (psi) | 495 | 520 | 530 | 515 |
| | f₆₀₀¹⁵⁰ - Stress at L/600 (psi) | 130 | 135 | 140 | 135 |
| | f₁₅₀¹⁵⁰ - Stress at L/150 (psi) | 110 | 120 | 125 | 120 |
| Toughness | T₁₅₀¹⁵⁰ - Toughness (in-lbs) | 190 | 210 | 210 | 203 |
| | f_{T,150}¹⁵⁰ or Fe_{3 mm} (psi) | 136 | 146 | 148 | 143 |
| | R_{T,150}¹⁵⁰ or Re_{3 mm} (%) | 28.3 | 28.1 | 30.2 | 28.9 |

TABLE 15
ASTM C1609 - Prior Fiber Art G at 5.00 PCY

| Specimen ID | | 1 | 2 | 3 | Avg |
|---|---|---|---|---|---|
| Specimen | Width (in.) | 5.90 | 5.90 | 5.90 | 5.90 |
| Dimensions | Depth (in.) | 5.95 | 5.95 | 6.00 | 5.95 |
| Initial | 8₁ - Deflection at First Crack (in.) | 0.0025 | 0.0021 | 0.0024 | 0.0023 |
| Deflections | 8_{P} - Deflection at Peak Load (in.) | 0.0027 | 0.0028 | 0.0027 | 0.0027 |
| Loads | P₁ - First Crack Load (lbf.) | 6,559 | 5,700 | 6,276 | 6,178 |
| | P - Peak Load (lbf.) | 6,579 | 6,636 | 6,315 | 6,510 |
| | P₆₀₀¹⁵⁰ - Load at L/600 (lbf.) | 1,352 | 1,049 | 1,167 | 1,189 |
| | P₁₅₀¹⁵⁰ - Load at L/150 (lbf.) | 1,317 | 921 | 975 | 1,071 |
| Stress | f₁ - First Crack Stress (psi) | 565 | 490 | 530 | 530 |
| | f_{P} - Peak Stress (psi) | 565 | 570 | 535 | 555 |
| | f₆₀₀¹⁵⁰ - Stress at L/600 (psi) | 115 | 90 | 100 | 100 |
| | f₁₅₀¹⁵⁰ - Stress at L/150 (psi) | 115 | 80 | 85 | 95 |
| Toughness | T₁₅₀¹⁵⁰ - Toughness (in-lbs) | 190 | 140 | 160 | 163 |
| | f_{T,150}¹⁵⁰ or Fe_{3 mm} (psi) | 136 | 101 | 113 | 117 |
| | R_{T,150}¹⁵⁰ or Re_{3 mm} (%) | 24.1 | 20.6 | 21.3 | 22.0 |

TABLE 16
ASTM C1609 - Prior Art Fiber H at 5.00 pcy

| Specimen ID | | 1 | 2 | 3 | Avg |
|---|---|---|---|---|---|
| Specimen | Width (in.) | 6.00 | 5.95 | 6.00 | 6.00 |
| Dimensions | Depth (in.) | 6.00 | 6.00 | 6.00 | 6.00 |
| Initial | 8₁ - Deflection at First Crack (in.) | 0.0023 | 0.0025 | 0.0024 | 0.0024 |
| Deflections | 8_{P} - Deflection at Peak Load (in.) | 0.0025 | 0.0026 | 0.0026 | 0.0026 |
| Loads | P₁ - First Crack Load (lbf.) | 6,170 | 6,671 | 6,265 | 6,369 |
| | P - Peak Load (lbf.) | 6,329 | 6,740 | 6,384 | 6,484 |
| | P₆₀₀¹⁵⁰ - Load at L/600 (lbf.) | 1,384 | 1,262 | 1,321 | 1,322 |
| | P₁₅₀¹⁵⁰ - Load at L/150 (lbf.) | 1,232 | 949 | 913 | 1,031 |
| Stress | f₁ - First Crack Stress (psi) | 515 | 560 | 520 | 530 |
| | f_{P} - Peak Stress (psi) | 525 | 565 | 530 | 540 |
| | f₆₀₀¹⁵⁰ - Stress at L/600 (psi) | 115 | 105 | 110 | 110 |
| | f₁₅₀¹⁵⁰ - Stress at L/150 (psi) | 105 | 80 | 75 | 85 |
| Toughness | T₁₅₀¹⁵⁰ - Toughness (in-lbs) | 180 | 160 | 170 | 170 |
| | f_{T,150}¹⁵⁰ or Fe_{3 mm} (psi) | 125 | 112 | 118 | 118 |
| | R_{T,150}¹⁵⁰ or Re_{3 mm} (%) | 24.3 | 20.0 | 22.7 | 22.3 |

TABLE 17
ASTM C1609 - Prior Art Fiber I at 5.00 PCY

| Specimen ID | | 1 | 2 | 3 | Avg |
|---|---|---|---|---|---|
| Specimen | Width (in.) | 5.90 | 5.95 | 6.00 | 5.95 |
| Dimensions | Depth (in.) | 5.90 | 6.05 | 6.00 | 6.00 |
| Initial | 8₁ - Deflection at First Crack (in.) | 0.0023 | 0.0021 | 0.0017 | 0.0020 |
| Deflections | 8_{P} - Deflection at Peak Load (in.) | 0.0024 | 0.0023 | 0.0017 | 0.0021 |
| Loads | P₁ - First Crack Load (lbf.) | 5,866 | 5,712 | 4,232 | 5,270 |
| | P - Peak Load (lbf.) | 5,930 | 6,078 | 5,904 | 5,971 |
| | P₆₀₀¹⁵⁰ - Load at L/600 (lbf.) | 1,262 | 1,191 | 1,191 | 1,215 |
| | P₁₅₀¹⁵⁰ - Load at L/150 (lbf.) | 1,204 | 1,267 | 1,185 | 1,219 |
| Stress | f₁ - First Crack Stress (psi) | 480 | 470 | 480 | 475 |
| | f_{P} - Peak Stress (psi) | 485 | 500 | 490 | 490 |
| | f₆₀₀¹⁵⁰ - Stress at L/600 (psi) | 110 | 100 | 100 | 105 |
| | f₁₅₀¹⁵⁰ - Stress at L/150 (psi) | 105 | 105 | 100 | 105 |
| Toughness | T₁₅₀¹⁵⁰ - Toughness (in-lbs) | 140 | 170 | 170 | 160 |
| | f_{T,150}¹⁵⁰ or Fe_{3 mm} (psi) | 102 | 117 | 118 | 112 |
| | R_{T,150}¹⁵⁰ or Re_{3 mm} (%) | 21.2 | 24.9 | 24.5 | 23.5 |

All industry standards referred to herein are incorporated by reference in their entireties.

We claim:

1. A macrosynthetic fiber for reinforcing concrete comprising two ends defining a length and two sides defining a width, a central panel spanning the length of the fiber and comprising a central panel axis and two borders, two areas of joinder spanning the length of each fiber and each said area of joinder comprising two faces, and two walls spanning the length of the fiber and each said wall comprising a top and a wall axis substantially parallel to the other wall axis, each border of said central panel being integral to one of said areas of joinder at one of said faces, and the other face of each said area of joinder being integral to one of the walls.

2. The fiber as in claim 1 wherein the fiber further comprises indentations.

3. The fiber as in claim 1 wherein the walls comprise an object selected from the group consisting of a cylinder, a rectangular prism, and an elliptical prism.

4. The fiber as in claim 1 wherein at least one of said areas of joinder further comprises a radius of approximately 0.0040 inches.

5. The fiber as in claim 1 wherein at least one of said areas of joinder comprises a radius within a range of approximately 0.0020-0.0060 inches.

6. The fiber as in claim 1 wherein at least one of said areas of joinder further comprises two or more angles having a sum totaling approximately 90 degrees.

7. The fiber as in claim 1 which, when the fiber is mixed at a dose exceeding three pounds per cubic yard of concrete, the concrete when hardened has a greater load value in a net deflection of L/150 than in a net deflection of L/600.

8. The fiber as in claim 7 wherein a difference in the load value in the net deflection of L/150 over the net deflection of L/600 increases as the dose of the fiber increases.

9. The fiber as in claim 1 wherein the fiber length is within a range of 1.00 to 3.00 inches.

10. The fiber as in claim 1 wherein each said wall is at a distance from the other said wall within a range of approximately 0.014-0.034 inches.

11. A macrosynthetic fiber for reinforcing concrete comprising a U-shape in cross-section and having a length and a width, said fiber further comprising a central panel comprising two borders, two walls each comprising a wall axis and extending only to one side of the central panel, and two areas of joinder comprising two faces, each said border being integral to one of the areas of joinder at one of the faces and the other face being integral to one of the walls, one of said wall axes being substantially parallel to the other wall axis.

12. The fiber as in claim 11 further comprising indentations.

13. The fiber as in claim 11 wherein the walls further comprise an object selected from the group consisting of a cylinder, a rectangular prism and an elliptical prism.

14. The fiber as in claim 11 wherein at least one of the areas of joinder further comprises a radius of approximately 0.0040 inches.

15. The fiber as in claim 11 wherein at least one of said areas of joinder further comprises a radius within a range of approximately 0.0020-0.0060 inches.

16. The fiber as in claim 11 wherein at least one of the areas of joinder further comprises two or more angles having a sum totaling approximately 90 degrees.

17. The fiber as in claim 11 which, when the fiber is mixed at a dose exceeding three pounds per cubic yard of concrete, the concrete when hardened has a greater load value in a net deflection of L/150 than in a net deflection of L/600.

18. The fiber as in claim 17 wherein a difference in the load value in the net deflection of L/150 over the net deflection of L/600 increases as the dose of the fiber increases.

19. The fiber as in claim 11 wherein the width is within a range of 0.020 to 0.060 inches.

20. The fiber as in claim 11 wherein each said wall is at a distance from the other said wall within a range of approximately 0.014-0.034 inches.

21. A macrosynthetic fiber for reinforcing concrete having a length and a width and an H-shape in cross-section, said fiber comprising a central panel comprising two borders, two walls each comprising a wall axis and extending to opposite sides of the central panel, and two areas of joinder comprising two faces, each said border being integral to one of the areas of joinder at one of the faces and the other face being integral to one of the walls, one of said wall axes being substantially parallel to the other wall axis.

22. The fiber as in claim 21 further comprising indentations.

23. The fiber as in claim 21 wherein the walls comprise an object selected from the group consisting of a cylinder, a rectangular prism and an elliptical prism.

24. The fiber as in claim 21 wherein at least one of the areas of joinder further comprises a radius of approximately 0.0040 inches.

25. The fiber as in claim 21 wherein at least one of the areas of joinder further comprises two or more angles having a sum totaling approximately 90 degrees.

26. The fiber as in claim 21 which, when the fiber is mixed at a dose exceeding three pounds per cubic yard of concrete, the concrete when hardened has a greater load value in a net deflection of L/150 than in a net deflection of L/600.

27. The fiber as in claim 26 wherein a difference in the load value in the net deflection of L/150 over the net deflection of L/600 increases as the dose of the fiber increases.

28. The fiber as in claim 21 wherein the length is within a range of 1.00 to 3.00 inches.

29. The fiber as in claim 21 wherein at least one of said areas of joinder comprises a radius within a range of 0.0020-0.0060 inches.

30. The fiber as in claim 21 wherein each said wall is at a distance from the other said wall within a range of approximately 0.014-0.034 inches.
